(19) United States
(12) Patent Application Publication
(10) Pub. No.: US 2025/0100272 A1
(43) Pub. Date: Mar. 27, 2025

(54) TREATMENT FORMULATIONS FOR USE WITH INTERMEDIATE TRANSFER MEMBERS

(71) Applicant: LANDA CORPORATION LTD., Rehovot (IL)

(72) Inventors: Einat TIROSH, Ramat Gan (IL); Helena CHECHIK, Rehovot (IL); Eran ARONOVITCH, Ness Ziona (IL); Parisa SHRAGA, Yavne (IL)

(21) Appl. No.: 18/729,096

(22) PCT Filed: Feb. 2, 2023
(86) PCT No.: PCT/IL2023/050117

§ 371 Date: Jul. 15, 2024

Related U.S. Application Data
(60) Provisional application No. 63/267,495, filed on Feb. 3, 2022.

(51) Int. Cl. B41J 2/04; B41J 2/01; C09D 11/102

(52) U.S. Cl. CPC B41J 2/04; C09D 11/102; B41J 2002/012

(57) ABSTRACT

The present disclosure relates to hydrophilic treatment formulations for use with intermediate transfer members of indirect printing systems and printing methods utilizing same. The present disclosure further relates to intermediate transfer members having a release layer surface covered with the formulations and to printed articles produced using the formulations.

### TECHNOLOGICAL FIELD

The present disclosure relates to indirect printing processes and systems, more particularly to treatment formulations suitable for the treatment of intermediate transfer members utilized in such processes and systems.

### BACKGROUND ART

The following patent publications [1] to [18] to the Applicant provide potentially relevant background material, and are all incorporated herein by reference in their entirety:
[1] WO/2013/132339 (publication of PCT/IB2013/000757);
[2] WO/2015/036960 (publication of PCT/IB2014/064444);
[3] WO/2015/036864 (publication of PCT/IB2014/002366);
[4] WO/2019/111223 (publication of PCT/IB2018/059761);
[5] WO/2020/141465 (publication of PCT/IB2020/050001);
[6] WO 2017/208246 (publication of PCT/IL2017/050616);
[7] WO/2020/003088 (publication of PCT/IB2019/055288);
[8] WO 2017/208152 (publication of PCT/IB2017/053177);
[9] WO 2013/132418 (publication of PCT/IB2013/051716);
[10] WO 2013/132439 (publication of PCT/IB2013/51755);
[11] WO 2015/036865 (publication of PCT/IB2014/02395);
[12] WO 2019/012456 (publication of PCT/IB2018/055126);
[13] WO 2020/136517 (publication of PCT/IB2019/061081);
[14] WO 2013/132420 (publication of PCT/IB2013/051718);
[15] WO 2015/036906 (publication of PCT/IB2014/064277);
[16] WO 2021/137063 (publication of PCT/IB2020/061673);
[17] U.S. Provisional Application No. 63/362,971; and
[18] WO 2013/132345 (publication of PCT/IB2013/000840).

Acknowledgement of the above references herein is not to be inferred as meaning that these are in any way relevant to the patentability of the presently disclosed subject matter.

### SUMMARY OF THE INVENTION

The inventors of the present invention have developed treatment formulations for use with an intermediate transfer member (ITM) of indirect printing systems.

As will be detailed herein below, the treatment formulations of the present invention are unique formulations with a unique sweating behavior at their dry state. The treatment formulations of the present invention are substantially devoid of cohesive agents and/or cohesive inducing agents such as water-soluble polymeric binders. The inventors have surprisingly found that removal of such agents affects the printing process and improves its performance. For example, the number of printing cycles of the printing system is increased due to decreased accumulation of treatment formulation ingredients on the ITM, thus eliminating the need for cleaning and/or polishing of the ITM and other parts of the printing system.

The treatment formulations were also found to be beneficial in terms of the improvement of system compatibility, demonstrating a decrease in filter clogging, phase separation (in its wet form) and tub contamination. Furthermore, the treatment formulations have the advantages of reduced image ghosting (which may be caused by the accumulation of the ingredients of the formulations on the ITM) and improved printing quality (e.g., improvements of uniformity of printing, ink wetting on the ITM, dot size, coffee stain, missing nozzles compensation and print head compatibility). In addition, the inventors found that the treatment formulations of the present invention significantly improved the transfer of images to a range of substances.

In the present invention, a release surface of an intermediate transfer member is pre-treated (e.g., coated) with the treatment formulations according to the present invention before deposition of an ink image thereto. The treatment formulation (referred to herein also as hydrophilic treatment formulation) is applied to a surface of an ITM to form thereon a thin wet treatment layer which is subjected to a drying process on the ITM release surface to leave a thin dried non-cohesive treatment layer on the ITM release surface. As opposed to previously disclosed treatment formulations that comprises a water-soluble polymeric binder and which form a thin dried film treatment layer on the ITM upon drying, the non-cohesive treatment layer of the present invention does not form a film on the ITM. The inventors of the present invention have surprisingly found that the treatment formulations of the present invention, once dried i.e., volatiles such as Volatile Organic Compounds (VOCs) and water are removed/evaporated therefrom, they form a non-cohesive layer on the ITM that illustrates a sweating behavior i.e., the treatment formulation forms (at times separates into) two phases, a dry solid (or semisolid) phase and an oily liquid phase. It is noted that at times the oily liquid phase may comprise traces (very little amounts) of water and/or another hydrophilic liquid.

Once the dry thin non-cohesive treatment layer is formed on the ITM, droplets of an aqueous ink are deposited (e.g. by ink-jetting) onto said layer to form an ink image thereon. It is noted that the ink droplets may be continuous or none-continuous. It is further noted that the ink droplets may cover the whole area of the dry thin non-cohesive treatment layer or part of the area thereof (the latter case results with regions on said layer with no ink deposited thereon). The formed ink-image is then subjected to a drying process to leave an ink residue on the non-cohesive treatment layer. The dried ink-image is then transferred from the ITM surface to a final printed substrate (e.g. foil-based, paper-based or plastic-based).

Thus, the present invention provides in a first one of its aspects a hydrophilic treatment formulation for use with an intermediate transfer member of a printing system, the hydrophilic treatment formulation comprising:
i. a liquid containing water, said liquid containing water making up between about 5% to about 97.5%, by weight, (at times between about 5% to about 95%, by weight) of the hydrophilic treatment formulation;
ii. at least one first non-ionic surfactant;
wherein said hydrophilic treatment formulation optionally further comprises one or more of:
iii. at least one second non-ionic surfactant;
iv. at least one humectant;
v. at least one wetting agent optionally being a first water-soluble polymeric wetting agent; and
vi. at least one antibacterial agent;
wherein a dry form of said hydrophilic treatment formulation is a non-cohesive form of a solid material (or a semisolid material) sweated with a non-volatile liquid oil.

In another one of its aspects the present invention provides a hydrophilic treatment formulation for use with an intermediate transfer member of a printing system, the hydrophilic treatment formulation comprising:
i. a liquid containing water, said liquid containing water making up between about 5% to about 97.5%, by weight, (at times between about 5% to about 95%, by weight) of the hydrophilic treatment formulation;
ii at least one first non-ionic surfactant having a solubility in water of at least about 7%, at 25° C., said first non-ionic surfactant making up between about 2.5% to about 95%, by weight, (at times between about 5% to about 95%, by weight) of the hydrophilic treatment formulation;
wherein said hydrophilic treatment formulation optionally further comprises one or more of:
iii. at least one second non-ionic surfactant having a solubility in water of at least 1%, at 25° C.;
iv. at least one humectant;
v. at least one wetting agent optionally being a first water-soluble polymeric wetting agent; and
vi. at least one antibacterial agent;
wherein a dry form of said hydrophilic treatment formulation is a non-cohesive form of a solid material (or a semisolid material) sweated with a non-volatile liquid oil.

In a further one of its aspects the present invention provides a hydrophilic treatment formulation for use with an intermediate transfer member of a printing system, the hydrophilic treatment formulation comprising:
i. a liquid containing water, said liquid containing water making up between about 5% to about 97.5%, by weight, (at times between about 5% to about 95%, by weight) of the hydrophilic treatment formulation;
ii. at least one first non-ionic surfactant;
wherein said hydrophilic treatment formulation optionally further comprises one or more of:
iii. at least one second non-ionic surfactant;
iv. at least one humectant;
v. at least one wetting agent optionally being a first water-soluble polymeric wetting agent; and
vi. at least one antibacterial agent,
wherein the hydrophilic treatment formulation is substantially devoid of a film forming agent.

In another one of its aspects the present invention provides a method of indirect printing comprising:
a. providing an intermediate transfer member (ITM) comprising a release layer surface;
b. providing the hydrophilic treatment formulation of the invention;
c. applying the hydrophilic treatment formulation onto the release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. drying said wet treatment layer (e.g., by keeping the ITM at a temperature sufficient to dry said wet treatment layer for example 90° C. to 130° C., and/or by subjecting said wet treatment layer to a drying process), to thereby form a dried non-cohesive sweating treatment layer from the wet treatment layer on the ITM release layer surface, said dried non-cohesive sweating treatment layer optionally having a thickness of at least about 20 nm and at most about 500 nm (at times at most about 450, 400, 350, 300, 250 or 200 nm);
e. depositing droplets of an aqueous ink, said aqueous ink comprising at least one binder and at least one colorant, onto at least a region of the dried non-cohesive sweating treatment layer, to form an ink image on the ITM release layer surface:
f. drying the ink image to leave an ink-image residue on the ITM release layer surface; and
g. transferring the ink-image residue onto a printing substrate by pressured contact between the ITM and the printing substrate.

In a further one of its aspects the present invention provides a method of indirect printing comprising:
a. providing an intermediate transfer member (ITM) comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°;
b. providing a hydrophilic treatment formulation of the invention e.g., the formulation comprises:
i. a liquid containing water, said liquid containing water making up between about 5% to about 97.5%, by weight, (at times between about 5% to about 95%, by weight) of the hydrophilic treatment formulation;
ii. at least one first non-ionic surfactant (e.g., having a solubility in water of at least about 7%, at 25° C.), optionally wherein said first non-ionic surfactant making up between about 2.5% to about 95%, by weight, (at times between about 5% to about 95%, by weight) of the hydrophilic treatment formulation;
wherein said hydrophilic treatment formulation optionally further comprises one or more of:
iii. at least one second non-ionic surfactant (e.g., having a solubility in water of at least 1%, at 25° C.);
iv. at least one non-polymeric humectant;
v. at least one wetting agent optionally being a first water-soluble polymeric wetting agent; and
vi. at least one antibacterial agent;
wherein said hydrophilic treatment formulation is devoid of a second water-soluble polymer (e.g., being a cohesive substance and/or a cohesion inducing substance), said second water-soluble polymer being different from the first water-soluble polymeric wetting agent; and
wherein said hydrophilic treatment formulation having the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight;
c. applying the hydrophilic treatment formulation to the silicone-based release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. drying said wet treatment layer (e.g., by keeping the ITM at a temperature sufficient to dry said wet treatment layer for example 90° C. to 130° C. and/or by subjecting said wet treatment layer to a drying process) to thereby form a dried non-cohesive treatment layer from the wet treatment layer on the silicone-based release layer surface, said dried non-cohesive treatment layer optionally having a thickness of at least about 20 nm and at most about 500 nm (at times at most about 450, 400, 350, 300, 250 or 200 nm);
e. depositing droplets of an aqueous ink, said aqueous ink comprising at least one binder and at least one colorant, onto at least a region of the dried non-cohesive treatment layer, to form an ink image on the release layer surface of the silicone-based release layer surface;
f. drying the ink image to leave an ink-image residue on the silicone-based release layer surface; and
g. transferring the ink-image residue onto a printing substrate by pressured contact between the ITM and the printing substrate.

In yet a further one of its aspects the present invention provides a system for indirect printing, the system comprising:
a. an intermediate transfer member (ITM) comprising a release layer surface;
b. a quantity of the hydrophilic treatment formulation of the invention;
c. a treatment station for applying the hydrophilic treatment formulation to the release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm):
d. means for subjecting the wet treatment layer to a drying process to form a dried non-cohesive sweating treatment layer from the wet treatment layer on the ITM release layer surface, said dried non-cohesive sweating treatment layer optionally having a thickness of at least about 20 nm and at most about 500 nm (at times at most about 450, 400, 350, 300, 250 or 200 nm);
e. at least one ink jet nozzle positioned proximate the intermediate transfer member and configured for jetting aqueous ink droplets, comprising at least one binder and at least one colorant, onto at least a region of the dried non-cohesive sweating treatment layer formed on the intermediate transfer member;
f. a drying station for drying the ink on the dried non-cohesive sweating treatment layer formed on the intermediate transfer member to leave an ink-image residue on the ITM release layer surface; and
g. an impression station for transferring the ink-image residue onto a printing substrate by pressured contact between the ITM and the printing substrate.

Yet, in a further one of its aspects the present invention provides a system for indirect printing, the system comprising:
a. an intermediate transfer member (ITM) comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°;
b. a quantity of a hydrophilic treatment formulation comprising:
i. a liquid containing water, said liquid containing water making up between about 5% to about 97.5%, by weight, (at times between about 5% to about 95%, by weight) of the hydrophilic treatment formulation;
ii. at least one first non-ionic surfactant (e.g., having a solubility in water of at least about 7%, at 25° C.), optionally wherein said first non-ionic surfactant making up between about 2.5% to about 95%, by weight, (at times between about 5% to about 95%, by weight) of the hydrophilic treatment formulation;
wherein said hydrophilic treatment formulation optionally further comprises one or more of:
iii. at least one second non-ionic surfactant (e.g., having a solubility in water of at least 1%, at 25° C.);
iv. at least one non-polymeric humectant;
V. at least one wetting agent optionally being a first water-soluble polymeric wetting agent; and
vi. at least one antibacterial agent;
wherein said hydrophilic treatment formulation is devoid of a second water-soluble polymer (e.g., being a cohesive substance and/or a cohesion inducing substance), said second water-soluble polymer being different from the first water-soluble polymeric wetting agent; and
wherein said hydrophilic treatment formulation having the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight;
c. a treatment station for applying the hydrophilic treatment formulation to the silicone-based release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. means for subjecting the wet treatment layer to a drying process to form a dried non-cohesive treatment layer from the wet treatment layer on the silicone-based release layer surface, said dried non-cohesive treatment layer optionally having a thickness of at least about 20 nm and at most about 500 nm (at times at most about 450, 400, 350, 300, 250 or 200 nm);
e. at least one ink jet nozzle positioned proximate the intermediate transfer member and configured for jetting aqueous ink droplets, comprising at least one binder and at least one colorant, onto at least a region of the dried non-cohesive treatment layer formed on the intermediate transfer member;
f. a drying station for drying the ink on the dried non-cohesive treatment layer formed on the intermediate transfer member to produce an ink-image residue on the silicone-based release layer surface; and
g. an impression station for transferring the ink-image residue onto a printing substrate by pressured contact between the ITM and the printing substrate.

In another one of its aspects the present invention provides a printed article comprising:
(i) a substrate;
(ii) one or more dry ink dots fixedly adhered to at least a region of a surface of said substrate,
wherein said one or more dry ink dots comprise at least one binder, at least one colorant and one or more of non-volatile ingredients of the hydrophilic treatment formulations of the present invention.

In yet another one of its aspects the present invention provides an intermediate transfer member comprising a release layer surface, wherein said surface is substantially covered with a dry non-cohesive sweating layer comprising one or more of the non-volatile ingredients of the hydrophilic treatment formulation of the present invention, and optionally wherein the thickness of said dry non-cohesive sweating layer being of at least about 20 nm and at most about 500 nm (at times at most about 450, 400, 350, 300, 250 or 200 nm).

In yet another one of its aspects the present invention provides an intermediate transfer member comprising a release layer surface, wherein said surface is substantially covered with the hydrophilic treatment formulation of the present invention.

In a further one of its aspects the present invention provides an intermediate transfer member comprising a release layer surface, wherein said surface is substantially covered with the hydrophilic treatment formulation of the present invention, and wherein when said intermediate transfer member is at a temperature being of between about 90° C. to about 130° C. (inclusive), a dried non-cohesive sweating treatment layer is form thereon, optionally wherein the thickness of said dry non-cohesive sweating layer being of at least about 20 nm and at most about 500 nm (at times at most about 450, 400, 350, 300, 250 or 200 nm).

Yet, in a further one of its aspects the present invention provides an intermediate transfer member comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°,
wherein said surface is substantially covered with a dry non-cohesive layer (non-film layer) comprising one or more of the ingredients of the hydrophilic treatment formulations of the present invention, and optionally wherein the thickness of said dry non-cohesive layer (non-film layer) being of at least about 20 nm and at most about 500 nm (at times at most about 450, 400, 350, 300, 250 or 200 nm).

In another one of its aspects the present invention provides treatment formulations as herein disclosed and exemplified.

In yet another one of its aspects the present invention provides intermediate transfer members as herein disclosed and exemplified.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a flow chart of an indirect printing process according to some embodiments of the invention.

FIG. 2 is a schematic side view of a printing system (e.g., digital printing system), according to some embodiments of the invention.

FIGS. 3A-3B display photographs of vials containing dry treatment formulations with (prior art) and without (the present invention) a binder, respectively.

FIGS. 4A-4C display photographs of vials containing solutions of treatment formulations of the invention (FIG. 4A and FIG. 4C), according to some embodiments of the invention, in comparison with a known treatment formulation (FIG. 4B).

FIGS. 5A-5B display printed images utilizing black and magenta inks (FIG. 5A and FIG. 5B, respectively) and the dot size measured utilizing treatment formulations of the invention, according to some embodiments of the invention, in comparison with a known treatment formulation.

FIG. 6 displays the graininess vs % coverage of magenta ink as observed with treatment formulations of the invention, according to some embodiments of the invention, in comparison with a known treatment formulation.

FIG. 7 displays the graininess vs % coverage of black ink as observed with treatment formulations of the invention, according to some embodiments of the invention, in comparison with a known treatment formulation.

FIGS. 8A-8B display printed images utilizing black and magenta inks (FIG. 8A) and the corresponding leftover ink on the intermediate transfer member (FIG. 8B), as observed with treatment formulations according to some embodiments of the invention.

### DETAILED DESCRIPTION OF THE INVENTION

Various embodiments will be detailed herein in connection with the disclosed invention. It is noted that one or more of these embodiments may be applicable to one or more aspects of the invention disclosed herein above and below. It is further noted that one or more embodiments which are detailed in connection with the treatment formulations of the invention may also be applicable to the other aspects of the invention as detailed herein e.g., methods, systems, processes, uses, printed articles and ITMs, and vice-versa.

In a first one of its aspects the present invention provides a hydrophilic treatment formulation for use with an intermediate transfer member of a printing system, the hydrophilic treatment formulation comprising:
i. a liquid containing water, said liquid containing water making up between about 5% to about 97.5%, by weight, (at times between about 5% to about 95%, by weight) of the hydrophilic treatment formulation;
ii. at least one first non-ionic surfactant;
wherein said hydrophilic treatment formulation optionally further comprises one or more of:
iii. at least one second non-ionic surfactant;
iv. at least one humectant;
v. at least one wetting agent optionally being a first water-soluble polymeric wetting agent; and
vi. at least one antibacterial agent;
wherein a dry form of said hydrophilic treatment formulation (e.g., when subjected to drying for example at a temperature of between about 90° C. to about 130° C., inclusive, to thereby substantially evaporate volatile liquids therefrom e.g., water and VOC) is a non-cohesive form of a solid or semisolid material sweated with a non-volatile liquid oil.

As used herein the term “dry form” or any lingual variations thereof is envisaged as a form substantially devoid of volatile liquids such as water, VOCs and the like e.g., traces amount of said liquids may be present in the form (for example, at most about 0.1 to about 2%, by weight of the form, at times at most about 0.1 to about 1%, by weight of the form). At times the dry form is completely devoid of volatile liquids such as water VOCs and the like.

As used herein, the term “VOCs” refers to organic compounds that have a high vapor pressure at room temperature. Specifically, to organic compounds that have boiling point which is below the temperature at which the printing process is performed e.g., below between about 90° C. to about 130° C.

Thus, in some embodiments a dry form of the hydrophilic treatment formulation of the invention is substantially devoid of water and VOCs and mainly comprises ingredients which boiling point is above the temperature at which the printing process is performed e.g., above 200° C., at times above 250° C., event at times above 300° C.

In some embodiments the non-volatile liquid oil is substantially devoid of water and VOCs and mainly comprises ingredients which boiling point is above the temperature at which the printing process is performed e.g., above 200° C., at times above 250° C., event at times above 300° C.

As uses herein the phrase “a non-cohesive form of a solid or semisolid material sweated with a non-volatile liquid oil” or any lingual variations thereof is envisaged as a dry form of the treatment formulation of the invention in which the dry treatment formulation forms two phases, a dry solid or semisolid phase and an oily liquid phase, the latter may be comprised of one or more oils and may further comprise traces of water and/or another hydrophilic liquid. The two phases may be completely separated or partly separated. For example, the two phases may form of a dispersion in which the oil phase is mixed within the solid phase or dispersed within the semisolid phase or vise versa.

As uses herein the term “semisolid” is interchangeable with the terms “quasi-solid”, “falsely-solid” or any lingual variations thereof and is referred to the physical term for something whose state lies between a solid and a liquid. While similar to solids in some respects, such as having the ability to support their own weight and hold their shapes, semisolid also shares some properties of liquids, such as conforming in shape to something applying pressure to it and the ability to flow under pressure.

In some embodiments the term semisolid refers to a gel.

In some embodiments the term semisolid refers to a semisolid liquid having a relatively high viscosity being above about 500 cp, at times being between about 500 cp to about 1000 cp.

In some embodiments, when the semisolid is a liquid with relatively high viscosity, a dry form of the treatment formulation of the present invention is envisaged as forming two phases, a semisolid non-volatile liquid phase and an oily non-volatile liquid phase. In some embodiments these two phases may be completely separated. In some embodiments these two phases may be partly separated. In some other embodiments these two phases may be in the form of a dispersion in which one phase is dispersed within the other, depending on the viscosities thereof, content thereof, temperature, time scale and other parameters.

It is noted that the oil liquid may be originated from one or more of the ingredients of the treatment formulation which may be provides in a liquid carrier which comprises one or more oils.

In some embodiments of the invention, the hydrophilic treatment formulation is devoid of a film forming agent.

In some embodiments of the invention, the hydrophilic treatment formulation is substantially devoid of a film forming agent.

As used herein the phrase “substantially devoid of a film forming agent” is envisaged as a case in which the hydrophilic treatment formulations of the invention may comprise to some extent a film forming agent, provided that the film forming agent is present in the formulations at a concentration that does not induce film formation e.g., on the ITM once the treatment formulation is dried thereon, for example, when utilized in the printing methods of the invention.

In some embodiments the film forming agent is a binder e.g., a water-soluble polymeric binder.

In some embodiments of the invention, the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

In some embodiments of the invention, the hydrophilic treatment formulation has the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight.

In some embodiments of the invention, the hydrophilic treatment formulation is devoid of a second water-soluble polymer, the second water-soluble polymer being different from the first water-soluble polymeric wetting agent.

In some embodiments of the invention, the second water-soluble polymer is a cohesive substance and/or a cohesion inducing substance.

In some embodiments of the invention, the second water-soluble polymer is a binder.

In some embodiments of the invention, the second water-soluble polymer is a water absorbing polymeric agent.

Non limiting examples of water absorbing polymeric agents which the treatment formulations of the invention are devoid of are: starches, including starch selected from corn starch, potato starch, rice starch, wheat flour, rice flour and corn flour.

In some embodiments of the invention, the second water-soluble polymer is a water absorbing polymeric agent with a repeating number of the monomeric unit thereof being 3 or above.

In some embodiments of the invention, the hydrophilic treatment formulation is devoid of a cohesive substance and/or a cohesion inducing substance, thereby once the hydrophilic treatment formulation is dried on the silicone-based release layer surface of the ITM, it does not form a film layer thereon.

In some embodiments of the invention, the hydrophilic treatment formulation is substantially devoid of a film forming agent.

In some embodiments of the invention, the film forming agent is a binder.

In some embodiments of the invention, the hydrophilic treatment formulation may comprise a film forming agent, provided that the film forming agent is present in the formulations of the invention at a concentration that does not induce film formation on the ITM once the treatment formulation is dried thereon.

In some embodiments of the invention, the hydrophilic treatment formulation is substantially devoid of a cohesive substance and/or a cohesion inducing substance, i.e., if such substances are present, they are present as very low concentration/s at which once the hydrophilic treatment formulation is dried on the release layer surface of the ITM, it does not form a film layer thereon.

In some embodiments of the invention, the at least one wetting agent is the only polymeric substance in the formulation of the invention.

In some embodiments of the invention, one or more of the at least one first and/or second non-ionic surfactant may be of a polymeric nature (being considered as a polymeric substance). To this end, such surfactants are not considered as being cohesive substances and/or a cohesion inducing substances. Further to this end, such polymeric surfactants may be water soluble polymers, being non-cohesive polymers or non-cohesion inducing polymers, and being different from the second water-soluble polymer.

In some embodiments of the invention, one or more of the at least one first and/or second non-ionic surfactant may be of a polymeric nature, and are present in the formulations of the invention at a concentration that does not induce film formation on the ITM once the treatment formulation is dried thereon.

In some embodiments of the invention, apart from the at least one first and/or second non-ionic surfactant, which may be of a polymeric nature (being considered as a polymeric substance), the hydrophilic treatment formulation is devoid of a second water-soluble polymer, the second water-soluble polymer being different from the first water-soluble polymeric wetting agent.

In some embodiments of the invention, one or more of the at least one first non-ionic surfactant may be of a polymeric nature (being considered as a polymeric substance) e.g., having for example a molecular weight of between about 1000 to 5000 g/mole. To this end, such surfactants are not considered as being cohesive substances and/or a cohesion inducing substances. Further to this end, such polymeric surfactants may be water soluble polymers, being non-cohesive polymers or non-cohesion inducing polymers.

In some embodiments of the invention, one or more of the at least one first non-ionic surfactant may be of a polymeric nature (being considered as a polymeric substance) and are present in the formulations of the invention at a concentration that does not induce film formation on the ITM once the treatment formulation is dried thereon.

In some embodiments of the invention, apart from the at least one first non-ionic surfactant which may be of a polymeric nature (being considered as a polymeric substance), the hydrophilic treatment formulation is devoid of a second water-soluble polymer, the second water-soluble polymer being different from the first water-soluble polymeric wetting agent.

In some embodiments of the invention, the at least one wetting agent is a polymeric agent present in the formulations of the invention at a concentration that does not induce film formation on the ITM once the treatment formulation is dried thereon.

In some embodiments of the invention, the hydrophilic treatment formulation is devoid of a second water-soluble polymeric substance. Such water-soluble polymeric substances have been disclosed in the patent publication to the Applicant WO/2020/141465 (PCT/IB2020/050001) [5] which content thereof is incorporated herein by reference.

In some embodiments of the invention, the second water-soluble polymer is a polymer with a repeating number of the monomeric unit thereof being 3 or above.

Non limiting examples of excluded water-soluble polymeric substances are: at least one modified polysaccharide such as cellulose ether e.g., methylcellulose and hydroxypropyl methylcellulose (HPMC)]; a binder e.g., PVA 6-88 and Metochel K-3; a resin; polyvinyl alcohol (PVA); water-soluble cellulose, polyvinylpyrrolidone (PVP); polyethylene oxide, water-soluble acrylates, or any combination thereof.

Further non limiting examples of excluded water-soluble polymeric substances are: polyvinyl alcohol (PVA), polyvinyl pyrrolidone (PVP), oxazoline, carbodiimide or any combination thereof.

Additional non limiting examples of excluded water-soluble polymeric substances are water-soluble resin such as polyvinyl alcohol, polyvinyl pyrrolidone, polyvinyl acetal, polyalkylene oxide, starch, cellulose derivatives such as methyl cellulose, hydroxy cellulose, hydroxypropyl cellulose, hydroxypropylmethyl cellulose and carboxymethyl cellulose, polyamide, various kinds of a water-soluble resin containing a quaternary ammonium salt group, and derivatives thereof.

Additional non limiting examples of excluded water-soluble polymeric substances are synthetic rubber such as vinyl acetate resins, ethylene vinyl acetate reins, acrylic reins, epoxy resins, polyester resins, polyamide resins, urethane resins, styrene-butadiene resins, acrylo-nitrile-butadiene resins and acrylic-butadiene resins.

In some embodiments of the invention, the treatment formulation of the invention is devoid of Methocel K3.

In some embodiments of the invention, the hydrophilic treatment formulation may be devoid of wax.

In some embodiments of the invention, the liquid containing water of the hydrophilic treatment formulation is water only or a mixture of water and at least one water soluble organic solvent e.g., ethanol and the like.

Non limiting examples of liquid containing water may be one or more water-soluble organic solvent such as alcohols, glycols, alkylene glycols having an alkylene group with a carbon number of 2 to 6, polyethylene glycols (provided that same are non-polymeric e.g., with numerous repeating units which are not considered polymeric), nitrogen-containing compounds, and sulfur-containing compounds.

In some embodiments of the invention, the hydrophilic treatment formulation may further comprise at least one first water-soluble polymeric wetting agent.

In some embodiments of the invention, the first water-soluble polymeric wetting agent is a multiple charged polymer e.g., a polycation or a polyanion.

Non limiting examples of a polycationic first water-soluble polymeric wetting agent are polyethyleneimine (PEI), poly (amidoamine) (PAMAM), poly-l-lysine (PLL) and poly (diallyl dimethyl ammonium) (PDDA).

In some embodiments of the invention the first water-soluble polymeric wetting agent is PEI.

In some embodiments of the invention the PEI is one or more of the following exemplary PEIs:

| | Charge Density, | Molecular Weight |
|---|---|---|
| Chemical Agent [Brand name] | meq/g | (gr/mole) |
| Polyethyleneimine (PEI) [Lupasol ® | 16 | 800 |
| FG] | | |
| PEI [Lupasol ® G 100] | 17 | 5,000 |
| PEI [Lupasol ® G 20] | 16 | 1,300 |
| PEI [Lupasol ® G 20 Waterfree] | 16 | 1,300 |
| PEI [Lupasol ® G 35] | 16 | 2,000 |
| PEI [Lupasol ® HF] | 17 | 25,000 |
| PEI [Lupasol ® P] | 20 | 750,000 |
| PEI, modified [Lupasol ® PN 50] | | 1,000,000 |
| PEI, modified [Lupasol ® PN 60] | | n/a |
| PEI, modified [Lupasol ® PO 100] | | 2,000 |
| PEI [Lupasol ® PR 8515] | 16 | 2,000 |
| PEI [Lupasol ® PS] | 20 | 750,000 |
| PEI, modified [Lupasol ® SK] | 8 | 2,000,000 |
| PEI [Lupasol ® WF] | 17 | 25,000 |

In some embodiments of the invention the PEI is provided in an aqueous solution (Lupasol® PS, BASF).

In some embodiments of the invention the PEI is provided in an aqueous solution (Lupasol® MI 6730).

In some embodiments of the invention the wetting agent is Poly (diallyldimethylammonium chloride) e.g., having Charge Density of about 6 meq/g and a molecular weight of about 200,000-300,000 gr/mole.

Non limiting examples of a polyanionic first water-soluble polymeric wetting agent are acrylic polymers, polyacryl amides and poly-DADMAc.

In some embodiments of the invention, apart from the first water-soluble polymeric wetting agent (e.g., polyethyleneimine) and at times apart from the at least one first and/or the at least one second non-ionic surfactants, the hydrophilic treatment formulation is devoid of a substance with a molecular weight being of about 1300 gr/mol and above. To this end, the hydrophilic treatment formulation might be referred to as small molecules containing treatment formulation.

Without wishing to be bound by theory, it is noted that while small molecules reduce the adhesion to the ITM at a scale of about 1:1, their effect on cohesion reduction is exponential, hence, presence of small molecules substances in the treatment formulation of the invention allows avoidance of cohesion between the formulation components but still maintaining the adhesion to the ITM, with the latter still being weaker than that of the adhesion to the final substrate for good transfer performance, optionally with no splitting of the non-cohesive layer during transfer (which is a relatively thick layer compared to a thinner layer of about 1 to 10 nm thickness known in the art e.g., WO/2015/036960 (PCT/IB2014/064444) [2]).

In some embodiments, one or more of the first and/or one or more of the second non-ionic surfactants may be of a molecular weight of between about 400 gr/mole to about 5000 gr/mole (inclusive), at times between about 1000 gr/mole to about 5000 gr/mole, inclusive. Any value in the above noted ranges is within the scope of the present invention.

In some embodiments, one or more of the first non-ionic surfactants may be of a molecular weight of between about 400 gr/mole to about 5000 gr/mole (inclusive), at times between about 1000 gr/mole to about 5000 gr/mole, inclusive. Any value in the above noted ranges is within the scope of the present invention.

It is noted that as opposed to small molecules, which may have a unique molecular weight readily derived from their chemical formula, generally provided in grams/mole, polymers and other macromolecules typically exist as a diverse population of distinct molecules, which are therefore characterized by an average molecular weight which may be expressed in Daltons. The molecular weight or average molecular weight of materials are generally provided by the manufacturer or supplier but can be independently determined by known analytical methods, including for instance gel permeation chromatography, high pressure liquid chromatography (HPLC) or matrix-assisted laser desorption/ionization time-of-flight mass spectroscopy MALDI-TOF MS. Average molecular weight (D50) may be based on the number of particles in the population (“D_{N}50”) or may be based on the volume of particles (D_{V}50). These measurements may be obtained by various known methods (e.g., DLS, microscopy). Thus, in some embodiments the molecular weigh value of components of the formulations of the present invention is an average molecular weight.

In some embodiments of the invention, the at least one wetting agent may be a plasticizer and/or a surface-active agent and/or an anchoring agent.

As used herein the term “anchoring agent” refers to an agent which enables improved adhesion to a specific surface due to its chemical nature. The anchoring agent may inter-alia serve to improve pinning of the treatment formulation to the ITM and reduce coalescence of the wet treatment coating from the ITM.

In some embodiments of the invention, the hydrophilic treatment formulation is further devoid of one or more of an inorganic salt, an inorganic metallic compound (e.g., Magnesium Nitrate Hexahydrate), a polyvalent metal ion and a metal ion.

In some embodiments of the invention, the hydrophilic treatment formulation is further devoid of an acid e.g., an organic acid.

In some embodiments of the invention, the hydrophilic treatment formulation is further devoid of a resolubilizing agent.

Non limiting examples of excluded resolubilizing agents are diols, triols, polyols, alcohols, sugars and modified sugars, ethers, polyethers, amino alcohol, amino silicones, styrene sulfonates, and combinations thereof.

Further non limiting examples of excluded resolubilizing agents are cocoamide diethanol amine, ethoxylated methyl glucose ether, Glucam™ E-10, Glucam™ E-20, glycerol, pentaerythritol, PEG 400, PEG 600, poly (sodium-4-styrenesulfonate), SilSense® Q-Plus Silicone, SilSense® A21 Silicone, sucrose, triethanol amine, triethylene glycol monomethyl ether, glycerol and triethanolamine.

In some embodiments of the invention, the hydrophilic treatment formulation is devoid of one or more of the ingredients excluded herein above and below.

In some embodiments of the invention, the hydrophilic treatment formulation is devoid of one or more of: a second water-soluble polymer; a cohesive substance and/or a cohesion inducing substance; a substance with a molecular weight being of about 1300 gr/mol and above; one or more of an inorganic salt, an inorganic metallic compound (e.g., Magnesium Nitrate Hexahydrate), a polyvalent metal ion and a metal ion; acid e.g., an organic acid; resolubilizing agent; or any combination thereof.

In some embodiments of the invention, the hydrophilic treatment formulation is devoid of one or more of: a second water-soluble polymer (as detailed above); a cohesive substance and/or a cohesion inducing substance; a substance with a molecular weight being of about 1300 gr/mol and above (at times, apart from the at least one first and/or the at least one second non-ionic surfactants which at times may be of a higher molecular weight); one or more of an inorganic salt, an inorganic metallic compound (e.g., Magnesium Nitrate Hexahydrate), a polyvalent metal ion and a metal ion; acid e.g., an organic acid; resolubilizing agent; or any combination thereof. In some embodiments of the invention, the total percent solids by weight of the hydrophilic treatment formulation is at least about 5%, or between about 5% to about 95% (inclusive), in particular between about 27% to about 95% (inclusive), even more particular between about 35% to about 95% (inclusive). Any value in the above noted ranges is within the scope of the present invention.

In some embodiments of the invention, the total percent solids by weight of the hydrophilic treatment formulation is between about 27% to about 40% (inclusive), in particular between about 29% to about 39% (inclusive). Any value in the above noted ranges is within the scope of the present invention.

In some embodiments of the invention, the total percent solids by weight of the hydrophilic treatment formulation between about 29% to 34%.

In some embodiments of the invention, the total percent solids by weight of the hydrophilic treatment formulation is 37.83%.

In some embodiments of the invention, the total percent solids by weight of the hydrophilic treatment formulation is 34.20%.

In some embodiments of the invention, the total percent solids by weight of the hydrophilic treatment formulation is 38.51%.

In some embodiments of the invention, the hydrophilic treatment formulation has a 60° C. evaporation load of at least about 1.86:1 by weight.

In some embodiments of the invention, the least one first non-ionic surfactant has a solubility in water of at least about 7%, at 25° C.

In some embodiments of the invention, the first non-ionic surfactant is a silicon containing surfactant or a non-silicon containing surfactant (e.g., polysorbate 20 i.e., Tween 20).

In some embodiments of the invention, the first non-ionic surfactant is a non-silicon containing surfactant. In some embodiments of the invention, the first non-ionic surfactants is non-silicon surfactant.

In some embodiments of the invention, the least one first non-ionic surfactant makes up between about 0.0% to about 95% (inclusive), by weight, of the hydrophilic treatment formulation. To this end, when a concentration of the at least one first non-ionic surfactant is 0.0% i.e., null, the treatment formulation comprises at least one another first non-ionic surfactant, at times at least two other first non-ionic surfactants.

In some embodiments of the invention, the least one first non-ionic surfactant makes up between about 2.5% to about 95% (inclusive), by weight, of the hydrophilic treatment formulation, at times between about 5% to about 95% (inclusive), at times between about 10% to about 95% (inclusive), at times between about 15% to about 95% (inclusive), at times between about 20% to about 95% (inclusive), at times between about 25% to about 95% (inclusive), even at times between about 35% to about 95% (inclusive), by weight, of the hydrophilic treatment formulation. Any value in the above noted ranges is within the scope of the present invention.

In some embodiments of the invention, the least one first non-ionic surfactant makes up about 24%, by weight, of the hydrophilic treatment formulation.

In some embodiments of the invention, the least one first non-ionic surfactant makes up between about 2.5% to about 24% (inclusive), by weight, of the hydrophilic treatment formulation. Any value in the above noted range is within the scope of the present invention.

In some embodiments of the invention, the least one first non-ionic surfactant makes up between about 5.5% to about 24% (inclusive), by weight, of the hydrophilic treatment formulation. Any value in the above noted range is within the scope of the present invention.

In some embodiments of the invention, the least one first non-ionic surfactant makes up between about 8.0% to about 15% (inclusive), by weight, of the hydrophilic treatment formulation. Any value in the above noted range is within the scope of the present invention.

In some embodiments of the invention, the least one first non-ionic surfactant makes up between about 8.0% to about 11.6% (inclusive), by weight, of the hydrophilic treatment formulation. Any value in the above noted range is within the scope of the present invention.

In some embodiments of the invention, the treatment formulation of the invention may comprise at least two first non-ionic surfactants, at times at least three first non-ionic surfactants.

In some embodiments of the invention, when the treatment formulation comprises more than one first non-ionic surfactant (e.g., at least two first non-ionic surfactants, at least three first non-ionic surfactants etc.) a total content of the first non-ionic surfactants makes up between about 2.5% to about 95% (inclusive), by weight, of the hydrophilic treatment formulation, at times between about 5% to about 95% (inclusive), at times between about 10% to about 95% (inclusive), at times between about 15% to about 95% (inclusive), at times between about 20% to about 95% (inclusive), at times between about 25% to about 95% (inclusive), even at times between about 35% to about 95% (inclusive), by weight, of the hydrophilic treatment formulation. Any value in the above noted ranges is within the scope of the present invention.

In some embodiments of the invention, the second non-ionic surfactant is a silicon containing surfactant (e.g., BYK LPX 23289) or a non-silicon containing surfactant.

In some embodiments of the invention, the second non-ionic surfactant is a non-silicon containing surfactant.

Non limiting examples of first and second non-ionic surfactants are those which have been disclosed in the patent publication to the Applicant WO/2019/111223 (PCT/IB2018/059761) [4] which content thereof is incorporated herein by reference.

In some embodiments of the invention, the first and the second non-ionic surfactants are non-silicon containing surfactants.

In some embodiments of the invention, the first and the second non-ionic surfactant are non-silicon surfactants.

In some embodiments of the invention, one or more of the first non-ionic surfactants are non-silicon containing surfactants.

In some embodiments of the invention, one or more of the second non-ionic surfactants are non-silicon containing surfactants.

In some embodiments of the invention, one or more of the first non-ionic surfactants are non-silicon surfactants.

In some embodiments of the invention, one or more of the second non-ionic surfactants are non-silicon surfactants.

In some embodiments the treatment formulation of the invention is devoid of a silicon containing surfactant.

In some embodiments the treatment formulation of the invention is devoid of a silicon surfactant.

In some embodiments the treatment formulation of the invention is devoid of the silicon surfactant BYK 23289.

In some embodiments the treatment formulation of the invention comprises at most about 0.25% by weight of a silicon containing surfactant or a silicon surfactant, at times at most about 0.20% by weight of a silicon containing surfactant or a silicon surfactant, even at times at most about 0.10% by weight of a silicon containing surfactant or a silicon surfactant.

Without wishing to be bound by theory, low contents of silicon surfactants in the formulations of the invention or absence thereof are advantageous at least in terms of less available sources of silicon on the planet. Further, silicone containing surfactants cause foaming of the formulations and avoiding of same is advantageous to the printing process and as well as the resulted printed article.

In some embodiments of the invention, the first non-ionic surfactant is, mainly includes, or includes a polyethoxylated sorbitan ester.

In some embodiments of the invention, the first non-ionic surfactant is, mainly includes, or includes a polyethoxylated sorbitan ester (e.g., Tween 20).

In some embodiments of the invention, the polyethoxylated sorbitan ester includes at least one species or at least two species selected from the group consisting of PEG-4 sorbitan monolaurate, PEG-20 sorbitan monolaurate, PEG-20 sorbitan monopalmitate, PEG-20 sorbitan monostearate, and PEG-20 sorbitan monooleate.

In some embodiments of the invention, the first non-ionic surfactant is, mainly includes, or includes a polyether such as Poly (propylene glycol)-block-poly (ethylene glycol)-block-poly (propylene glycol) (e.g., Pluronic 10R5).

In some embodiments of the invention, the first non-ionic surfactant is, mainly includes, or includes a glycoside such as alkyl polyglycoside C8-10 (e.g., Disponil APG 215).

In some embodiments of the invention the treatment formulation comprises a first non-ionic surfactant selected from a polyethoxylated sorbitan ester (e.g., Tween 20), a polyether (e.g., Pluronic 10R5), a glycoside (e.g., Disponil APG 215) or any combinations thereof.

In some embodiments of the invention, the at least one first non-ionic surfactant is Tween 20, making up between about 0.0% to about 95% (inclusive), at times between about 2.5% to about 95% (inclusive), by weight, of the hydrophilic treatment formulation. Any value in the above noted ranges is within the scope of the present invention.

In some embodiments of the invention, the at least one first non-ionic surfactant is Tween 20, making up between about 2.5% to about 24% (inclusive), by weight, of the hydrophilic treatment formulation. Any value in the above noted range is within the scope of the present invention.

In some embodiments of the invention, the at least one first non-ionic surfactant is Tween 20, making up between about 5.5% to about 24% (inclusive), by weight, of the hydrophilic treatment formulation. Any value in the above noted range is within the scope of the present invention.

In some embodiments of the invention, the at least one first non-ionic surfactant is Pluronic 10R5, making up between about 0.0% to about 95% (inclusive), at times between about 2.5% to about 95% (inclusive), by weight, of the hydrophilic treatment formulation. Any value in the above noted ranges is within the scope of the present invention.

In some embodiments of the invention, the at least one first non-ionic surfactant is Pluronic 10R5, making up between about 8.0% to about 15% (inclusive), by weight, of the hydrophilic treatment formulation. Any value in the above noted range is within the scope of the present invention.

In some embodiments of the invention, the at least one first non-ionic surfactant is Disponil APG 215, making up between about 0.0% to about 64% (inclusive), at times between about 2.5% to about 64% (inclusive), by weight, of the hydrophilic treatment formulation. Any value in the above noted ranges is within the scope of the present invention.

In some embodiments of the invention, at the least one first non-ionic surfactant is Disponil APG 215, making up between about 8.0% to about 11.6% (inclusive), by weight, of the hydrophilic treatment formulation. Any value in the above noted range is within the scope of the present invention.

In some embodiments of the invention, the treatment formulation comprises a polyethoxylated sorbitan ester first non-ionic surfactant, a polyether first non-ionic surfactant, and a glycoside first non-ionic surfactant, wherein said polyethoxylated sorbitan ester making up between about 2.5% to about 24% (inclusive), at times between about 5.5% to about 24% (inclusive), event at times between about 2.5% to about 6.0% (inclusive), by weight, of the hydrophilic treatment formulation, wherein said polyether making up between about 8.0% to about 15% (inclusive), by weight, of the hydrophilic treatment formulation, and wherein said glycoside making up between about 8.0% to about 11.6% (inclusive), by weight, of the hydrophilic treatment formulation. Any value in the above noted ranges is within the scope of the present invention.

In some embodiments of the invention, the treatment formulation comprises the first non-ionic surfactants Tween 20, Pluronic 10R5, and Disponil APG 215, wherein said Tween 20 making up between about 2.5% to about 24% (inclusive), at times between about 5.5% to about 24% (inclusive), event at times between about 2.5% to about 6.0% (inclusive), by weight, of the hydrophilic treatment formulation, wherein said Pluronic 10R5 making up between about 8.0% to about 15% (inclusive), by weight, of the hydrophilic treatment formulation, and wherein said Disponil APG 215 making up between about 8.0% to about 11.6% (inclusive), by weight, of the hydrophilic treatment formulation. Any value in the above noted ranges is within the scope of the present invention.

In some embodiments of the invention, the at least one second non-ionic surfactant has a solubility in water of at least 1%, at 25° C.

In some embodiments of the invention, the second, non-ionic silicone-containing surfactant includes a polysiloxane-polyoxyalkylene copolymer.

In some embodiments of the invention, the second non-ionic surfactant making up at most 10%, by weight, (inclusive) of the hydrophilic treatment formulation. Any value between 0% to 10% (inclusive), at times between 0% to 5.0% (inclusive), is within the scope of the present invention.

In some embodiments of the invention, the second non-ionic surfactant makes up about 4%, by weight of the hydrophilic treatment formulation.

In some embodiments of the invention, the second non-ionic surfactant makes up about 5%, by weight of the hydrophilic treatment formulation.

In some embodiments of the invention, the second non-ionic surfactant is, mainly includes, or includes a thioether (e.g., Dynol 360).

In some embodiments of the invention, the second non-ionic surfactant is, mainly includes, or includes an ethoxylated alcohol such as ethoxylated acetylenic diols (e.g., Dynol 604) and/or ethoxylated 2,4,7,9-tetramethyl 5 decyn-4,7-diol (e.g., Surfinol 465).

In some embodiments of the invention, the second non-ionic surfactant is an ethoxylated alcohol selected from ethoxylated acetylenic diols (e.g., Dynol 604), ethoxylated 2,4,7,9-tetramethyl 5 decyn-4,7-diol (e.g., Surfinol 465) or a combination thereof.

In some embodiments of the invention, the second non-ionic surfactant is selected from a thioether, an ethoxylated alcohol or any combination thereof.

In some embodiments of the invention the treatment formulation comprises a second non-ionic surfactant selected from at least one thioether, at least one ethoxylated alcohol or any combination thereof.

In some embodiments of the invention the treatment formulation comprises a second non-ionic surfactant selected from Dynol 360, Dynol 604, Surfinol 465 or any combinations thereof.

In some embodiments of the invention the treatment formulation is devoid of a second non-ionic surfactant selected from Dynol 360, Dynol 604, Surfinol 465 or any combinations thereof.

In some embodiments of the invention, the at least one second non-ionic surfactant is Dynol 360, making up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the at least one second non-ionic surfactant is Dynol 604, making up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the at least one second non-ionic surfactant is Surfinol 465, making up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the treatment formulation of the invention may comprise at least two second non-ionic surfactants, at times at least three non-ionic surfactants.

In some embodiments of the invention, when the treatment formulation comprises more than one second non-ionic surfactant (e.g., two second non-ionic surfactants, three second non-ionic surfactants etc.) a total content of the second non-ionic surfactants makes up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the treatment formulation comprises a polyethoxylated sorbitan ester first non-ionic surfactant, a polyether first non-ionic surfactant, and a glycoside first non-ionic surfactant, wherein said polyethoxylated sorbitan ester making up between about 2.5% to about 24% (inclusive), at times between about 5.5% to about 24% (inclusive), by weight, of the hydrophilic treatment formulation, wherein said polyether making up between about 8.0% to about 15% (inclusive), by weight, of the hydrophilic treatment formulation, and wherein said glycoside making up between about 8.0% to about 11.6% (inclusive), by weight, of the hydrophilic treatment formulation; and wherein the treatment formulation may further comprise a second non-ionic surfactant selected from at least one thioether, at least one ethoxylated alcohol or any combination thereof, wherein a total content of said second non-ionic surfactant makes up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the treatment formulation comprises the first non-ionic surfactants Tween 20, Pluronic 10R5, and Disponil APG 215, wherein said Tween 20 making up between about 2.5% to about 24% (inclusive), at times between about 5.5% to about 24% (inclusive), by weight, of the hydrophilic treatment formulation, wherein said Pluronic 10R5 making up between about 8.0% to about 15% (inclusive), by weight, of the hydrophilic treatment formulation, and wherein said Disponil APG 215 making up between about 8.0% to about 11.6% (inclusive), by weight, of the hydrophilic treatment formulation; and wherein the treatment formulation may further comprise a second non-ionic surfactant selected from Dynol 360, Dynol 604, Surfinol 465 or any combinations thereof, wherein a total content of said second non-ionic surfactant makes up between about 0.0% to about 10% (inclusive), at times between about 0.0% to about 5% (inclusive), by weight, of the hydrophilic treatment formulation. Any value in the above noted ranges is within the scope of the present invention.

In some embodiments of the invention, the hydrophilic treatment formulation may further comprise at least one wetting agent (e.g., polyethyleneimine), the wetting agent (e.g., polyethyleneimine) making up at most about 1%, by weight, of said hydrophilic treatment formulation, in particular at most about 0.20%, more particular 0.20% of the hydrophilic treatment formulation. Any value between 0 to 1% is within the scope of the present invention.

In some embodiments of the invention, the hydrophilic treatment formulation may further comprise at least one humectant, the humectant making up at most about 30%, by weight, of the hydrophilic treatment formulation. Any value between 0 to 30% is within the scope of the present invention.

In some embodiments of the invention, the humectant makes about 10%, by weight, of the hydrophilic treatment formulation.

In some embodiments of the invention, the humectant is a sugar making about 10%, by weight, of the hydrophilic treatment formulation.

In some embodiments of the invention, the at least one humectant is a non-polymeric humectant (e.g., sorbitol, xylitol, a monosaccharide, a disaccharide).

To this end, in some embodiments of the invention the treatment formulation is devoid of polysaccharides such starch, cellulose, guar gum, locust bean gum, fenugreek gum, Tara gum, curdlan, and carrageenan. Also cationic polysaccharide such as polysaccharides combined with an amino group and an amine salt; natural polysaccharides, such as chitosan, containing an amino group; quaternary or ternary nitrogen-containing halides such as glycidyltrimethylammonium chloride, 3-chloro-2-hydroxypropyltrimethylammonium chloride, 3-chloropropyltrimethylammonium chloride, and glycidyltriethylammonium chloride; halohydrins; and epoxides are excluded from the treatment formulation of the invention.

In some embodiments of the invention, an HLB number of a first and/or a second non-ionic surfactant is at least 11, at least 12, at least 13, at least 14, or at least 14.5, and optionally, at most 22, at most 21, at most 20, at most 19, at most 18, or at most 17, and further optionally, within a range of 11 to 25, 11 to 23, 11.5 to 21, 11.5 to 20, 11.5 to 18, 12.5 to 21, 12.5 to 20, 12.5 to 18, 13.5 to 21, 13.5 to 20, 13.5 to 18, 14 to 20.5, 14 to 18.5, 14.5 to 20, 14.5 to 19, 14.5 to 18, or 14.5 to 17.5.

In some embodiments of the invention, the HLB number of the first and/or second non-ionic surfactant is within the range of 11 to 25.

In some embodiments of the invention, the HLB number of the first and/or second non-ionic surfactant is within the range of 14.5 to 20.

In some embodiments of the invention, the hydrophilic treatment formulation may further comprise at least one antibacterial agent (e.g., K12N or any other antibacterial agent known in the art), wherein the antibacterial agent making up at most about 1%, by weight, of the hydrophilic treatment formulation. Any value between 0 to 1% is within the scope of the present invention.

In some embodiments of the invention, the antibacterial agent makes about 0.20%, by weight, of the hydrophilic treatment formulation.

In some embodiments of the invention, the hydrophilic treatment formulation comprises one or more of:
at least one first non-ionic surfactant, said first non-ionic surfactant making up between about 2.5% to about 95%, by weight (at times between about 5% to about 95%, by weight), of the hydrophilic treatment formulation.
at least one second non-ionic surfactant, said second non-ionic surfactant making up at most 10%, by weight, (inclusive) of said hydrophilic treatment formulation;
at least one wetting agent, said wetting agent (e.g., polyethyleneimine) making up at most about 1%, by weight, of said hydrophilic treatment formulation, in particular at most about 0.20%, more particular 0.20% of said hydrophilic treatment formulation;
at least one humectant, said humectant making up at most about 30%, by weight, of said hydrophilic treatment formulation; and
at least one antibacterial agent making up at most about 1%, by weight, of the hydrophilic treatment formulation.

It is noted that any value in the range of the ingredient's content (% by weight) detailed herein above and below is withing the scope of the present invention.

In some embodiments of the invention, the at least one humectant is a non-polymeric humectant e.g., sorbitol, xylitol, a monosaccharide, a disaccharide.

In some embodiments of the invention, the ingredients of the hydrophilic treatment formulation are compatible with each other and with the liquid containing water, thus the hydrophilic treatment formulation being a stable solution with no phase separation and with no sedimentation/precipitation at 25° C.

In some embodiments of the invention, the hydrophilic treatment formulation is a clear colorless solution at 25° C.

In some embodiments of the invention, the hydrophilic treatment formulation is a transparent solution at 25° C.

Exemplary non limiting list of surfactants that provide clear colorless solution (transparent solution) of the treatment formulation of the present invention, alone or in any combination with each other, are Tween 20, Pluronic 10R5, Disponil APG 215, Dynol 360, Dynol 604 and Surfinol 465.

In some embodiments of the invention, the ingredients of the hydrophilic treatment formulation do not form aggregates with the colorant of an aqueous ink utilized in the printing system/process.

In some embodiments of the invention, the treatment formulation of the invention has the following content (referred to herein as Formulation A):

| Components | Concentration w/w % |
|---|---|
| BYK 23289 | 3.82 |
| Loxanol MI 6730 | 0.2 |
| Sugar | 9.60 |
| Tween 20 | 24.01 |
| Mergal K12N | 0.20 |
| Water | 62.17 |
| % solids | 37.83% |

In some embodiments of the invention, the treatment formulation of the invention has the following content (referred to herein as Formulation C):

| Components | Concentration w/w % |
|---|---|
| Pluronic 10R5 | 8.1 |
| Disponil APG 215 | 11.6 |
| Loxanol MI 6730 | 0.2 |
| Sugar | 7.7 |
| Dynol 360 | 3.90 |
| Tween 20 | 2.5 |
| Mergal K12N | 0.20 |
| Water | 65.8 |
| % solids | 34.2% |

In some embodiments of the invention, the treatment formulation of the invention has the following content (referred to herein as Formulation D):

| Components | Concentration w/w % |
|---|---|
| Pluronic 10R5 | 14.7 |
| Disponil APG 215 | 8.8 |
| Loxanol MI 6730 | 0.29 |
| Sugar | 8.8 |
| Tween 20 | 5.9 |
| Mergal K12N | 0.20 |
| Water | 61.31 |
| % solids | 38.51% |

In some embodiments of the invention, the treatment formulation of the invention has the following content (referred to herein as Formulation E):

| Components | Concentration w/w % |
|---|---|
| Pluronic 10R5 | 8.1 |
| Disponil APG 215 | 11.6 |
| Loxanol MI 6730 | 0.2 |
| Sugar | 7.7 |
| Tween 20 | 2.5 |
| Mergal K12N | 0.20 |
| Water | 69.7 |
| % solids | 34.2% |

In some embodiments of the invention, the treatment formulation of the invention has the following content (referred to herein as Formulation F):

| Components | Concentration w/w % |
|---|---|
| Pluronic 10R5 | 14.7 |
| Disponil APG 215 | 8.8 |
| Loxanol MI 6730 | 0.2 |
| Sugar | 7.7 |
| Tween 20 | 2.5 |
| Mergal K12N | 0.20 |
| Water | 65.9 |
| % solids | 34.2% |

In some embodiments of the invention, the treatment formulations of the invention have the following content (various concentration ranges of the components are provided):

| Components | Concentration w/w % |
|---|---|
| Pluronic 10R5 | 8.0-15.0 |
| Disponil APG 215 | 8.0-11.6 |
| Loxanol MI 6730 | 0.2 |
| Sugar | 7.7 |
| Dynol 360 | 0-5 |
| Tween 20 | 2.5 |
| Mergal K12N | 0.20 |
| Water | Complete to 100% total |
| % solids | ~29-34% |

Other concentration ranges are within the scope of the present invention.

In a further one of its aspects the present invention provides a hydrophilic treatment formulation for use with an intermediate transfer member of a printing system, the hydrophilic treatment formulation comprising:
i. a liquid containing water, said liquid containing water making up between about 5% to about 97.5%, by weight, (at times between about 5% to about 95%, by weight) of the hydrophilic treatment formulation;
ii. at least one first non-ionic surfactant;
wherein said hydrophilic treatment formulation optionally further comprises one or more of:
iii. at least one second non-ionic surfactant;
iv. at least one humectant;
v. at least one wetting agent optionally being a first water-soluble polymeric wetting agent; and
vi. at least one antibacterial agent,
wherein the hydrophilic treatment formulation is substantially devoid of a film forming agent.

In another one of its aspects the present invention provides a method of indirect printing comprising:
a. providing an intermediate transfer member (ITM) comprising a release layer surface;
b. providing the hydrophilic treatment formulation of the invention;
c. applying the hydrophilic treatment formulation onto the release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. drying said wet treatment layer to thereby form a dried non-cohesive sweating treatment layer from the wet treatment layer on the ITM release layer surface, said dried non-cohesive sweating treatment layer optionally having a thickness of at least about 20 nm and at most about 500 nm (at times at most about 450, 400, 350, 300, 250 or 200 nm):
e. depositing droplets of an aqueous ink, said aqueous ink comprising at least one binder and at least one colorant, onto at least a region of the dried non-cohesive sweating treatment layer, to form an ink image on the ITM release layer surface:
f. drying the ink image to leave an ink-image residue on the ITM release layer surface; and
g. transferring the ink-image residue onto a printing substrate by pressured contact between the ITM and the printing substrate.

In some embodiments of the invention, the drying in step (b) may be by keeping the ITM at a temperature sufficient to dry said wet treatment layer for example a temperature between about 90° C. to about 130° C., and/or by subjecting said wet treatment layer to a drying process.

In some embodiments of the invention the drying in step (b) may be by keeping the ITM at a temperature sufficient to dry said wet treatment layer for example a temperature between about 90° C. to about 130° C.

In some embodiments of the invention the drying in step (b) may be by subjecting said wet treatment layer to a drying process.

In some embodiments of the invention, the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

In some embodiments of the invention, the hydrophilic treatment formulation is substantially devoid of a cohesive substance and/or a cohesion inducing substance thereby once said hydrophilic treatment formulation is dried on the release layer surface of the ITM it does not form a film layer thereon.

In some embodiments of the invention, the hydrophilic treatment formulation may comprise a cohesive substance and/or a cohesion inducing substance at concentrations that are insufficient to form a film layer on the release layer surface of the ITM once the hydrophilic treatment formulation is dried thereon.

In some embodiments, in the method of the invention the drying in step (d) is performed at a temperature of between about 90° C. to about 130° C., inclusive.

In some embodiments of the invention, the dried non-cohesive sweating treatment layer is comprised of a solid material sweated with a non-volatile liquid oil.

In some embodiments of the invention, the dried non-cohesive sweating treatment layer is comprised of a semisolid material sweated with a non-volatile liquid oil.

In some embodiments of the invention, the dried non-cohesive sweating treatment layer is colorless.

In some embodiments of the invention, the ingredients of the hydrophilic treatment formulation do not form aggregates with the colorant of the aqueous ink.

In some embodiments, in the method of the invention, in step (g), to some extent, the dry non-cohesive sweating treatment layer, in both printed and non-printed regions on the ITM, is transferred to the printing substrate, together with the ink-image residue, leaving a residual dry non-cohesive sweating treatment layer on the ITM or a residual dry non-cohesive non-sweating treatment layer on the ITM.

Without wishing to be bound by theory, at times the transfer may result with leaving a residual dry non-cohesive treatment layer without the liquid oil i.e., leaving a non-sweated dry non-cohesive treatment layer, the latter comprises solids or semisolids only or mainly comprises solids or semisolids (optionally with trace amount of oil phase).

In some embodiments of the invention, the method comprises several repeating cycles of steps (c) to (g) (e.g., 1000 cycles), and wherein between each cycle the newly applied hydrophilic treatment formulation in step (c) completely dissolves/solubilize said residual dry non-cohesive sweating treatment layer or said residual dry non-cohesive non-sweating treatment layer of the previous cycle, thereby no accumulation of said residual layer/s between each of said cycles occurs. To this end, the need of a cleaning station for cleaning the ITM may be redundant. Further to this end, utilizing re-solubilization agents in the hydrophilic treatment formulations of the invention may be redundant.

In some embodiments, in the method of the invention, the droplets of the aqueous ink are deposited onto the dry non-cohesive sweating treatment layer, a surface of said dry non-cohesive sweating treatment layer, which is in close contact with said aqueous ink, is capable of dissolving into said aqueous ink and/or mix and/or blend with said aqueous ink, optionally forming an intermediate phase comprising one or more ingredients of said hydrophilic treatment formulation and the ink ingredients.

The inventors of the present invention have surprisingly found that the hydrophilic treatment formulation of the present invention provide advantages to the printing process as detailed herein above when utilized with a broad spectrum of inks (e.g., Y, M, C, K, O, G, B) and thus are considered as universal to all inks including e.g., R and W, without manifestation of any damage to the printing quality, color gamut etc.

The hydrophilic treatment formulation of the present invention are also applicable to be used with inks of relatively high static surface tension (being of above 25.5 mN/m at room temperature, for example about 26 mN/m) as well as low surface tension (being of about 23.0 to about 25.5 mN/m at room temperature, for example about 24 mN/m). Such exemplary inks are disclosed in U.S. Provisional Application No. 63/362,971 [17], the content of each is incorporated herein by reference. Without wishing to be bound by theory, in some embodiments of the invention the dry solid/semisolid and/or the oil phase may dissolve/mix/blend.

In some embodiments of the invention, the ink-image residue may comprise one or more ingredients of the hydrophilic treatment formulation, for example, at least one liquid oil originated from the hydrophilic treatment formulation and/or at least one solid/semisolid ingredient.

In some embodiments of the invention, the ink-image residue is free of aggregates.

In a further one of its aspects the present invention provides a method of indirect printing comprising:
a. providing an intermediate transfer member (ITM) comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°;
b. providing a hydrophilic treatment formulation of the invention e.g., the formulation comprises:
i. a liquid containing water, said liquid containing water making up between about 5% to about 97.5%, by weight, (at times between about 5% to about 95%, by weight) of the hydrophilic treatment formulation;
ii. at least one first non-ionic surfactant (e.g., having a solubility in water of at least about 7%, at 25° C.), optionally wherein said first non-ionic surfactant making up between about 2.5% to about 95%, by weight, (at times between about 5% to about 95%, by weight) of the hydrophilic treatment formulation;
wherein said hydrophilic treatment formulation optionally further comprises one or more of:
iii. at least one second non-ionic surfactant (e.g., having a solubility in water of at least 1%, at 25° C.);
iv. at least one non-polymeric humectant;
v. at least one wetting agent optionally being a first water-soluble polymeric wetting agent; and
vi. at least one antibacterial agent;
wherein said hydrophilic treatment formulation is devoid of a second water-soluble polymer (e.g., being a cohesive substance and/or a cohesion inducing substance), said second water-soluble polymer being different from the first water-soluble polymeric wetting agent; and
wherein said hydrophilic treatment formulation having the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight;
c. applying the hydrophilic treatment formulation to the silicone-based release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. drying said wet treatment layer (e.g., by keeping the ITM at a temperature sufficient to dry said wet treatment layer for example 90° C. to 130° C. and/or by subjecting said wet treatment layer to a drying process) to thereby form a dried non-cohesive treatment layer from the wet treatment layer on the silicone-based release layer surface, said dried non-cohesive treatment layer optionally having a thickness of at least about 20 nm and at most about 500 nm (at times at most about 450, 400, 350, 300, 250 or 200 nm);
e. depositing droplets of an aqueous ink, said aqueous ink comprising at least one binder and at least one colorant, onto at least a region of the dried non-cohesive treatment layer, to form an ink image on the release layer surface of the silicone-based release layer surface:
f. drying the ink image to leave an ink-image residue on the silicone-based release layer surface; and
g. transferring the ink-image residue onto a printing substrate by pressured contact between the ITM and the printing substrate.

In yet a further one of its aspects the present invention provides a system for indirect printing, the system comprising:
a. an intermediate transfer member (ITM) comprising a release layer surface;
b. a quantity of the hydrophilic treatment formulation of the invention;
c. a treatment station for applying the hydrophilic treatment formulation to the release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. means for subjecting the wet treatment layer to a drying process to form a dried non-cohesive sweating treatment layer from the wet treatment layer on the ITM release layer surface, said dried non-cohesive sweating treatment layer optionally having a thickness of at least about 20 nm and at most about 500 nm (at times at most about 450, 400, 350, 300, 250 or 200 nm);
e. at least one ink jet nozzle positioned proximate the intermediate transfer member and configured for jetting aqueous ink droplets, comprising at least one binder and at least one colorant, onto at least a region of the dried non-cohesive sweating treatment layer formed on the intermediate transfer member;
f. a drying station for drying the ink on the dried non-cohesive sweating treatment layer formed on the intermediate transfer member to leave an ink-image residue on the ITM release layer surface; and
g. an impression station for transferring the ink-image residue onto a printing substrate by pressured contact between the ITM and the printing substrate.

In some embodiments of the invention, the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

In some embodiments the system of the invention is configured for preforming the method of the invention.

Yet, in a further one of its aspects the present invention provides a system for indirect printing, the system comprising:
a. an intermediate transfer member (ITM) comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°;
b. a quantity of a hydrophilic treatment formulation comprising:
i. a liquid containing water, said liquid containing water making up between about 5% to about 97.5%, by weight, (at times between about 5% to about 95%, by weight) of the hydrophilic treatment formulation;
ii. at least one first non-ionic surfactant (e.g., having a solubility in water of at least about 7%, at 25° C.), optionally wherein said first non-ionic surfactant making up between about 2.5% to about 95%, by weight, (at times between about 5% to about 95%, by weight) of the hydrophilic treatment formulation;
wherein said hydrophilic treatment formulation optionally further comprises one or more of:
iii. at least one second non-ionic surfactant (e.g., having a solubility in water of at least 1%, at 25° C.);
iv. at least one non-polymeric humectant;
v. at least one wetting agent optionally being a first water-soluble polymeric wetting agent; and
vi. at least one antibacterial agent;
wherein said hydrophilic treatment formulation is devoid of a second water-soluble polymer (e.g., being a cohesive substance and/or a cohesion inducing substance), said second water-soluble polymer being different from the first water-soluble polymeric wetting agent; and
wherein said hydrophilic treatment formulation having the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight;
c. a treatment station for applying the hydrophilic treatment formulation to the silicone-based release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. means for subjecting the wet treatment layer to a drying process to form a dried non-cohesive treatment layer from the wet treatment layer on the silicone-based release layer surface, said dried non-cohesive treatment layer optionally having a thickness of at least about 20 nm and at most about 500 nm (at times at most about 450, 400, 350, 300, 250 or 200 nm);
e. at least one ink jet nozzle positioned proximate the intermediate transfer member and configured for jetting aqueous ink droplets, comprising at least one binder and at least one colorant, onto at least a region of the dried non-cohesive treatment layer formed on the intermediate transfer member;
f. a drying station for drying the ink on the dried non-cohesive treatment layer formed on the intermediate transfer member to produce an ink-image residue on the silicone-based release layer surface; and
g. an impression station for transferring the ink-image residue onto a printing substrate by pressured contact between the ITM and the printing substrate.

In yet a further one of its aspects the present invention provides a printed article comprising:
(i) a substrate;
(ii) one or more dry ink dots fixedly adhered to at least a region of a surface of said substrate,
wherein said one or more dry ink dots comprise at least one binder, at least one colorant and one or more of non-volatile ingredients of the hydrophilic treatment formulations of the invention.

In some embodiments of the invention, the printed article is devoid of ingredients that the treatment formulations are devoid/free of, as detailed herein above and below.

In some embodiments of the invention, in the printed article the dry one or more ink dots are further covered with a dry non-cohesive layer (which may be a sweating layer) comprising one or more of the non-volatile ingredients of the hydrophilic treatment formulation.

In some embodiments of the invention, in the printed article, non printed regions of the substrate are covered with a dry non-cohesive sweating layer comprising one or more of the non-volatile ingredients of the hydrophilic treatment formulation.

In some embodiments, the printed article of the invention is produced/producible according to the method of the invention.

In some embodiments, the one or more dry ink dots of the printed article of the invention are each characterized by a dimensionless aspect ratio (R_{aspect}) defined by:

$${R}_{aspect} = {D}_{dot} / {H}_{dot}$$

wherein D_{dot} is a diameter, characteristic diameter, average diameter, or longest diameter of the dot; and
H_{dot} is a thickness, characteristic thickness, or average thickness of the dot, or the height of the top surface of dot with respect to the substrate.

In some embodiments the values of the R_{aspect}, the D_{dot} and the H_{dot} are as detailed herein below.

Yet, in a further one of its aspects the present invention provides an intermediate transfer member comprising a release layer surface, wherein the surface is substantially covered with a dry non-cohesive sweating layer comprising one or more of the non-volatile ingredients of the hydrophilic treatment formulation of the invention, and optionally wherein the thickness of the dry non-cohesive sweating layer being of at least about 20 nm and at most about 500 nm (at times at most about 450, 400, 350, 300, 250 or 200 nm).

In some embodiments, the dry non-cohesive sweating layer covers at least 50% or at least 75% or at least 90% or at least 95% at least 95% or at least 99% or 100% of the intermediate transfer member release layer surface.

In another one of its aspects the present invention provides an intermediate transfer member comprising a release layer surface, wherein the surface is substantially covered with the hydrophilic treatment formulation of the invention.

In a further one of its aspects the present invention provides an intermediate transfer member comprising a release layer surface, wherein said surface is substantially covered with the hydrophilic treatment formulation of the present invention, and wherein when said intermediate transfer member is at a temperature being of between about 90° C. to about 130° C. (inclusive), a dried non-cohesive sweating treatment layer is form thereon, optionally wherein the thickness of said dry non-cohesive sweating layer being of at least about 20 nm and at most about 500 nm.

In some embodiments of the invention, the ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

In some embodiments of the invention the wet treatment layer optionally has a thickness of at most about 5.0 μm, at times of at most about 4.5, 4.0, 3.5, 3.0, 2.5, 2.0, 1.5 or 1.0 μm, and the dried non-cohesive (e.g., sweating) treatment layer optionally has a thickness of at least about 20 nm and at most about 500 nm, at times at most about 450, 400, 350, 300, 250 or 200 nm. Any combination between the aforementioned values is withing the scope of the present invention.

In some embodiments of the invention the wet treatment layer has a thickness of about 1.0 μm and the dried non-cohesive (e.g., sweating) treatment layer has a thickness of about 350 nm.

Yet, in a further one of its aspects the present invention provides an intermediate transfer member comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°,
wherein said surface is substantially covered with a dry non-cohesive layer (non-film layer) comprising one or more of the ingredients of the hydrophilic treatment formulations of the present invention, and optionally wherein the thickness of said dry non-cohesive layer (non-film layer) being of at least about 20 nm and at most about 500 nm.

The printed ink dots that are produced utilizing the treatment formulations of the present invention may each be characterized by the dimensionless aspect ratio (R_{aspect}) (as defined above).

In some embodiments D_{dot} or D_{dot average} may be in the range of 10-300 micrometers, 10-250 μm, 15-250 μm, 15-200μ, 15-150μ, 15-120μ, or 15-100 μm. More typically, D_{dot} or D_{dot average} may be in the range of 20-120 μm, 25-120 μm, 30-120 μm, 30-100 μm, 40-120 μm, 40-100 μm, or 40-80 μm.

In some embodiments D_{dot} or D_{dot average}, may be at least 10 micrometers, at least 15 μm, or at least 20 μm, at least 30 μm, at least 40 μm, and more typically, at least 50 μm, at least 60 μm, or at least 75 μm.

In some embodiments D_{dot} or D_{dot average}, may be of between about 60 μm to about 300 μm (inclusive), at times between about 60 μm to about 200 μm (inclusive), at times between about 60 μm to about 150 μm (inclusive), even at times between about 60 μm to about 105 μm (inclusive). Any value in the above noted ranges is within the scope of the present invention.

In some embodiments D_{dot} or D_{dot average}, may be of between about 75 μm to about 300 μm (inclusive), at times between about 75 μm to about 200 μm (inclusive), at times between about 75 μm to about 150 μm (inclusive), even at times between about 75 μm to about 105 μm (inclusive). Any value in the above noted ranges is within the scope of the present invention.

In some embodiments D_{dot} Or D_{dot average} may be at most 300 micrometers, at most 250 μm, or at most 200 μm, and more typically, at most 175 μm, at most 150 μm, at most 120 μm, or at most 100 μm.

In some embodiments the D_{dot} or D_{dot average} may be 30 to 50 microns bigger than that obtained with known treatment formulations (the latter including a binder and a silicone surfactant).

In some embodiments the aspect ratio R_{aspect} may be at least 15, at least 20, at least 25, or at least 30, at least 40, at least 50, and more typically, at least 60, at least 75.

In some embodiments the aspect ratio R_{aspect} may be at least 95, at least 110, at at least 120, at least 150, at least 180, or at least 200.

In some embodiments the aspect ratio R_{aspect} may be of between about 100 to about 400 (inclusive), at times between about 100 to about 350 (inclusive), even at times between about 100 to about 300 (inclusive). Any value in the above noted ranges is within the scope of the present invention.

In some embodiments the aspect ratio R_{aspect} is typically below 450.

The printing process of the present invention is an indirect printing process in which a release surface of an ITM is pre-treated (e.g., coated) with a treatment formulation according to the invention before deposition of an ink image thereto. The treatment formulation is applied to a surface of an ITM to form thereon a thin wet treatment layer which is subjected to a drying process on the ITM release surface to leave a thin dried non-cohesive treatment layer on the ITM release surface. Then after, droplets of an aqueous ink formulation are deposited by ink-jetting onto the thin dried non-cohesive treatment layer to form an ink image thereon. The formed ink-image is then subjected to a drying process to leave an ink residue on the non-cohesive treatment layer. The dried ink-image is then transferred (to some extent together with the non-cohesive treatment layer and/or together with at least one ingredient of the non-cohesive treatment layer, see below), from the ITM surface to a final printed substrate.

Examples of similar printing processes and systems mutatis mutandis are disclosed in the patent publications to the Applicant WO 2017/208152 (PCT/IB2017/053177) [8] and WO 2013/132418 (PCT/IB2013/051716) [9], which content thereof is incorporated herein by reference.

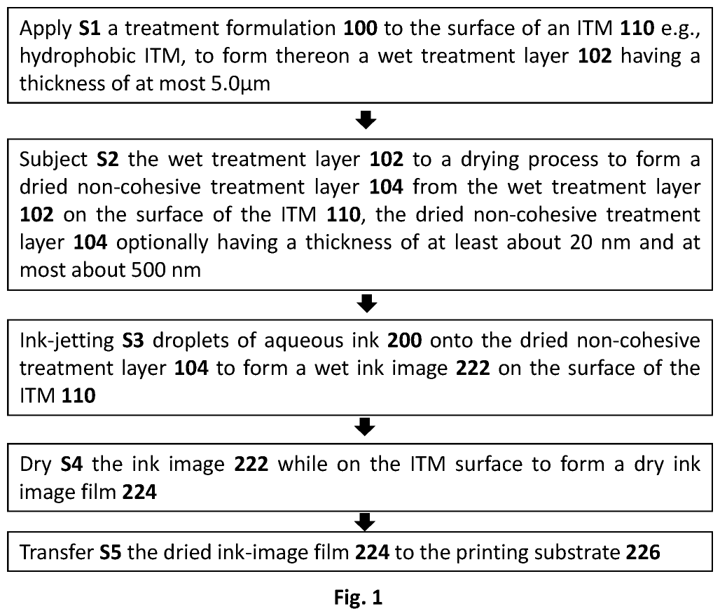

FIG. 1 is a flow chart of a printing process according to some embodiments of the invention where an intermediate transfer member (ITM) is pre-treated with the treatment formulation of the present invention before deposition of an ink droplets thereto. In step S1 of FIG. 1 a treatment formulation (e.g., 100) of the present invention is applied to a surface of an ITM 110 e.g., hydrophobic ITM to form thereon a wet treatment layer 102 optionally having a thickness of at most 5.0 μm. In step S2 of FIG. 1 the wet treatment layer 102 is dried (e.g., by drying means and/or by the heat of the ITM and/or by the heat of hot air adjacent to the ITM), to form a dried non-cohesive treatment layer 104 from the wet treatment layer 102 on the surface of the ITM 110, the dried non-cohesive treatment layer 104 optionally having a thickness of at least about 20 nm and at most about 500 nm. In step S3 of FIG. 1, droplets of aqueous ink 200 are ink-jetted onto the dried non-cohesive treatment layer 104 to form a wet ink image 222 on the surface of the ITM 110. In step S4 of FIG. 1 the ink image 222 is dried on the ITM surface to form a dried ink image film 224. In step S5 of FIG. 1 the dried ink-image film 224 is transferred to a printing substrate 226, typically by pressure contacting.

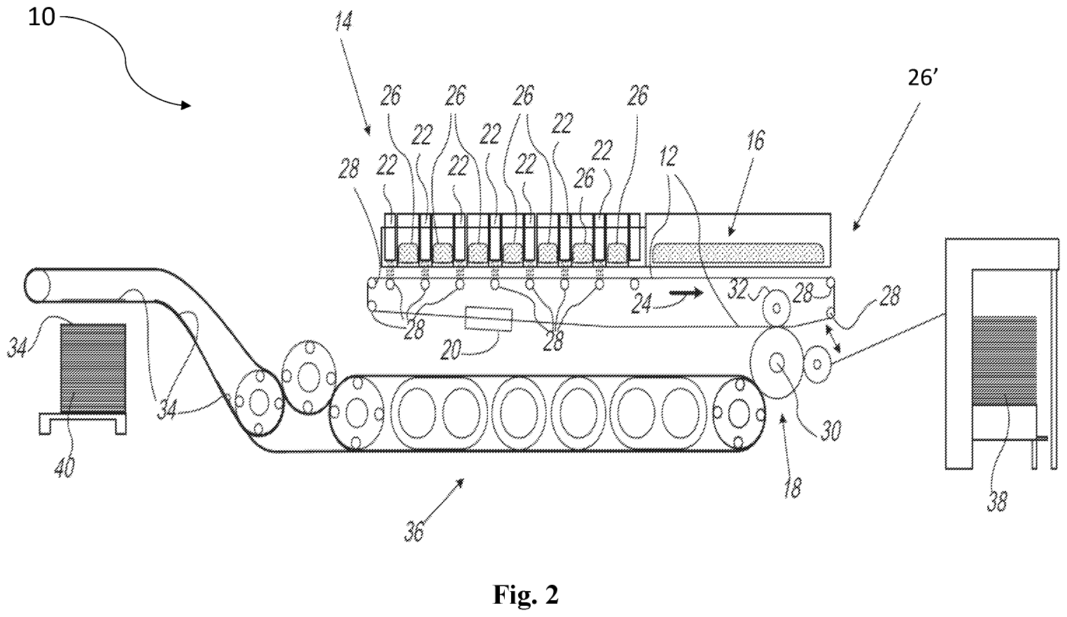

FIG. 2 provides an illustration of an exemplary indirect printing system. Specifically, FIG. 2 is a schematic side view of a digital printing system 10, in accordance with some embodiments of the invention. In some embodiments, system 10 comprises a rolling flexible blanket 12 that cycles through an image forming station 14, a drying station 16, an impression station 18 and a blanket treatment station 20.

As used herein the term “blanket” refers to a flexible transfer member that can be mounted within a printing device to form a belt-like structure on two or more rollers, at least one of which is able to rotate and move the blanket (e.g., by moving the belt thereof) to travel around the rollers.

As used herein, the terms “blanket” and “intermediate transfer member” (ITM) are used interchangeably and refer to a flexible member comprising at least a release layer used as an intermediate member configured to receive an ink image and to transfer the ink image to a target substrate.

In an operative mode, image forming station 14 is configured to form a mirror ink image, also referred to herein as “an ink image” (not shown), of a digital image on an upper run of a surface of blanket 12. Subsequently the ink image is transferred to a target substrate, (e.g., a paper, a folding carton, or any suitable flexible package in a form of sheets or continuous web) located under a lower run of blanket 12.

As used herein, the terms “ink image” and “image” are interchangeable. At times, said terms refer to an image formed on blanket 12 and transferred to a target substrate. At times they refer to the printed image on the substrate itself (e.g., a paper, a folding carton, or any suitable flexible package in a form of sheets or continuous web). Thus, these terms should be interpreted in the context of the text in which they are used.

As used herein, the term “run” refers to a length or segment of blanket 12 between any two given rollers over which blanket 12 is guided.

In some embodiments, during installation blanket 12 may be adhered (e.g., seamed) edge to edge to form a continuous blanket loop (not shown). An example of a method and a system for the installation of the seam is described in detail in the patent publication to the Applicant WO 2019/012456 (PCT/IB2018/055126) [12], the disclosure thereof is incorporated herein by reference.

In some embodiments, image forming station 14 typically comprises multiple print bars 22, each mounted (e.g., using a slider) on a frame (not shown) positioned at a fixed height above the surface of the upper run of blanket 12. In some embodiments, each print bar 22 comprises a strip of print heads as wide as the printing area on blanket 12 and comprises individually controllable print nozzles.

In some embodiments, image forming station 14 may comprise any suitable number of bars 22, each bar 22 may contain a printing fluid, such as an aqueous ink formulation of a different color. The ink typically has visible colors, such as but not limited to cyan, magenta, red, green, blue, yellow, black and white. In the example of FIG. 2, image forming station 14 comprises seven print bars 22, but may comprise, for example, four print bars 22 having any selected colors such as cyan, magenta, yellow and black.

In some embodiments, the print heads are configured to jet ink droplets of the different colors onto the surface of blanket 12 so as to form the ink image (not shown) on the surface of blanket 12.

In some embodiments, different print bars 22 are spaced from one another along the movement axis of blanket 12, represented by an arrow 24. In this configuration, accurate spacing between bars 22, and synchronization between directing the droplets of the ink of each bar 22 and moving blanket 12 are essential for enabling correct placement of the image pattern.

In some embodiments, system 10 comprises heaters, such as hot gas or air blowers 26, which are positioned in between print bars 22, and are configured to partially dry the ink droplets deposited on the surface of blanket 12.

This hot air flow between the print bars may assist, for example, in reducing condensation at the surface of the print heads and/or in handling satellites (e.g., residues or small droplets distributed around the main ink droplet), and/or in preventing blockage of the inkjet nozzles of the print heads, and/or in preventing the droplets of different color inks on blanket 12 from undesirably merging into one another. In some embodiments, system 10 comprises a drying station 16, configured to blow hot air (or another gas) onto the surface of blanket 12. In some embodiments, drying station comprises air blowers or any other suitable drying apparatus.

In drying station 16, the ink image formed on blanket 12 is exposed to radiation and/or to hot air in order to dry the ink more thoroughly, evaporating most or all of the liquid carrier and leaving behind only a layer of resin and coloring agent which is heated to the point of being rendered tacky ink film.

In some embodiments, system 10 comprises a blanket transportation assembly 26′, configured to move a rolling ITM, such as a blanket 12. In some embodiments, blanket transportation/guiding assembly 26′ comprises one or more rollers 28, wherein at least one of rollers 28 comprises an encoder (not shown), which is configured to record the position of blanket 12, so as to control the position of a section of blanket 12 relative to a respective print bar 22. In some embodiments, the encoder of roller 28 typically comprises a rotary encoder configured to produce rotary-based position signals indicative of an angular displacement of the respective roller.

Additionally or alternatively, blanket 12 may comprise an integrated encoder (not shown) for controlling the operation of various modules of system 10. The integrated encoder is described in detail, for example, in the patent publication to the Applicant WO 2020/003088 (PCT/IB2019/055288) [7], the disclosure thereof is incorporated herein by reference.

In some embodiments, system 10 comprises an impression station 18, wherein blanket 12 passes between an impression cylinder 30 and a pressure cylinder 32, which is configured to carry a compressible blanket.

In some embodiments, system 10 comprises a control console (not shown), which is configured to control multiple modules and assemblies of system 10.

In some embodiments, blanket treatment station 20, which can also serve as a cooling station, is configured to treat the blanket by, for example, cooling it and/or applying a treatment fluid to the outer surface of blanket 12. The treatment may be carried out by passing blanket 12 over one or more rollers or blades configured for applying cooling and/or treatment fluid on the outer surface of the blanket.

In some embodiments, blanket treatment station 20, is also configured to heat/evaporate/dry the treatment formulation applied on the ITM.

In some embodiments the blanket treatment station 20 may include a cleaning station configured to clean the outer surface of blanket 12.

The cleaning station can constitute a part of the treatment station or be a separate station located between the transfer station and the treatment station described in detail, for example, in the patent publication to the Applicant WO 2021/137063 (PCT/IB2020/061673) [16], the disclosure thereof is incorporated herein by reference.

It should be noted, however, that due to the reduction in accumulation of treatment formulation ingredients on the ITM, there is little or no need to clean and/or polish the ITM and other corresponding parts of the printing system.

In the example of FIG. 2, station 20 is mounted between two rollers 28, yet, station 20 may be mounted adjacent to blanket 12 at any other suitable location between impression station 18 and image forming station 14.

In some embodiments, impression cylinder 30 of impression station 18, is configured to impress the ink image onto the target substrate, such as an individual sheet 34, conveyed by substrate transport module 36 (schematically shown) from an input stack 38 to an output stack 40 via impression cylinder 30. In some embodiments, the target substrate may comprise any suitable substrate, such as but not limited to a flexible substrate, a partially flexible substrate (e.g., having flexible sections and rigid sections), or a rigid substrate.

In some embodiments, system 10 comprises an additional impression station (not shown), so as to permit duplex printing (i.e., printing on both sides of sheet 34).

In alternative embodiments, a different configuration of substrate conveyor 36 may be used for printing on a continuous web substrate, as disclosed for example in PCT International Publication WO 2020/136517 (PCT/IB2019/061081) [13]. Detailed descriptions and various configurations of sheet-fed simplex and duplex printing systems and of systems for printing on continuous web substrates are provided, for example, in PCT International Publications WO 2013/132420 (PCT/IB2013/051718) and in PCT International Publication WO 2015/036906 (PCT/IB2014/064277) [15], the disclosure of each is incorporated herein by reference.

The particular configurations of system 10 are shown by way of example. Embodiments of the present invention, however, are by no means limited to this specific sort of example system, and the principles described herein may similarly be applied to any other sorts of printing systems.

Non-limiting examples of ink formulations which may be used in the present invention are ink formulations disclosed in patent applications/publications to the Applicant WO 2013/132439 (PCT/IB2013/51755) [10], WO 2015/036865 (PCT/IB2014/02395) [11], WO 2017/208152 (PCT/IB2017/053177) [8], and U.S. Provisional Application No. 63/362,971 [17], the content of each is incorporated herein by reference.

In some embodiments the target substrate (printed substrate) is selected from the group consisting of an uncoated fibrous printing substrate, a commodity coated fibrous printing substrate, and a plastic printing substrate.

In some embodiments the target substrate is a fibrous printing substrate e.g., a paper.

In some embodiments the fibrous printing substrate is a paper selected from the group of papers consisting of bond paper, uncoated offset paper, coated offset paper, copy paper, groundwood paper, coated groundwood paper, freesheet paper, coated freesheet paper, and laser paper.

In some embodiments the printing substrate is a coated or uncoated offset substrate.

In some embodiments the fibrous printing substrate is a commodity-coated printing substrate.

In some embodiments the target substrate is a plastic.

In some embodiments the plastic printing substrate is a plastic selected from the group consisting of biaxially oriented polypropylene (BOPP), anti-static polyester and atactic polypropylene.

Exemplary non limiting substates are uncoated paper 140 gsm and Burgo 130 gsm.

Further non limiting exemplary printing substrates are those which have been disclosed in the patent publication to the Applicant WO 2013/132345 (PCT/IB2013/000840) which content thereof is incorporated herein by reference.

The treatment formulation of the present invention may affect the graininess behaviour of the ink image produced utilizing them.

Graininess (solid-area graininess in the specified color plane) refers to irregular fluctuations of density at a spatial frequency less than a specified tile size.

In some embodiments the graininess behaviour of an ink image produced utilizing the treatment formulations of the present invention is as herein disclosed and exemplified.

In some embodiments the treatment formulation of the present invention, when utilized in the printing process of the invention, provides a graininess behaviour of an ink image at 30-80% of ink coverage which is substantially constant e.g., the graininess at 30% coverage is not more than twice of the graininess at 80% coverage.

In some embodiments the treatment formulation of the present invention is free of a silicane surfactant and when utilized in the printing process of the invention it provides a graininess behaviour of an ink image at 30-80% of ink coverage with a graininess value at 30% coverage being not more than twice of the graininess values at 80% coverage e.g., compared to a treatment formulation that comprises a silicane surfactant and provides a graininess value at 30% coverage being 4 times or more (e.g., 5, 6 or 7 times more) of the graininess values at 80% coverage.

Unless otherwise stated, the term “concentration” refers to a w/w—i.e., a weight of a component/ingredient of a formulation per total weight of the formulation in its wet form, prior to drying.

As used herein the term “receding contact angle” or “RCA”, refers to a receding contact angle as measured using a Dataphysics OCA15 Pro Contact Angle measuring device, or a comparable Video-Based Optical Contact Angle Measuring System, using the Drop Shape Method. The analogous “advancing contact angle”, or “ACA”, refers to an advancing contact angle measured substantially in the same fashion.

As used herein the term “dynamic contact angle” or “DCA”, refers to a dynamic contact angle as measured using a Dataphysics OCA15 Pro Contact Angle measuring device, or a comparable Video-Based Optical Contact Angle Measuring System, using the method elaborated by Dr. Roger P. Woodward (in “Contact Angle Measurements Using the Drop Shape Method”, inter alia, www.firsttenangstroms.com/pdfdocs/CAPaper.pdf), at ambient temperatures.

As used herein the term “image transfer member” or “intermediate transfer member” or “transfer member” refers to the component of a printing system upon which the ink is initially applied by the printing heads, for instance by inkjet heads, and from which the jetted image is subsequently transferred to another substrate or substrates, typically, the final printing substrates.

As used herein the term “blanket” refers to a flexible transfer member that can be mounted within a printing device to form a belt-like structure on two or more rollers, at least one of which is able to rotate and move the blanket (e.g. by moving the belt thereof) to travel around the rollers.

As used herein, the terms “blanket”, “intermediate transfer member”, ITM are used interchangeably and refer to a flexible member comprising a stack of layers used as an intermediate member configured to receive a wet hydrophilic treatment formulation which receives an ink image and to transfer the dried ink image film to a target substrate, as described herein.

As used herein the term ‘Static surface tension’ refers to the static surface tension at 25° C. and atmospheric pressure.

In some embodiments, the term ‘thickness’ of a wet layer is defined as follows. When a volume of material vol covers a surface area of a surface having an area SA with a wet layer—the thickness of the wet layer is assumed to be vol/SA.

In some embodiments, the term ‘thickness’ of a dry layer is defined as follows. When a volume of material vol that is x % liquid, by weight, wets or covers a surface area SA of a surface, and all the liquid is evaporated away to convert the wet layer into a dry layer, a thickness of the dry layer is assumed to be:

$$vol / {ρ}_{wet layer} ( 100 - x ) / ( SA \cdot {ρ}_{dry layer} )$$

where ρ_{wet layer} is the specific gravity of the wet layer and ρ_{dry layer} is the specific gravity of the dry layer.

In some embodiments, the term ‘thickness’ of a dry layer is a total thickness of both the solid (or semisolid) material and the non-volatile oil.

In some embodiments of the invention, the hydrophilic treatment formulations are applied onto the ITM to form a continuous wet later. As used herein the term ‘continuous wet layer’ or any lingual variations thereof refers to a continuous wet layer that covers a convex region without any bare sub-regions within a perimeter of the convex region.

In some embodiments of the invention, the dry hydrophilic treatment formulations onto the ITM form a continuous thin dried layer, in particular a non-cohesive layer. As used herein the term ‘continuous thin dried layer’ or any lingual variations thereof refers to a continuous dried layer that covers a convex region without any discontinuities within a perimeter of the convex region.

As used herein the term ‘cohesive substance’ refers to a substance that a construct comprising thereof (e.g., a film) stay together when peeled away from a surface to which it is adhered. As used herein the term ‘cohesive inducing substance’ refers to a substance that induces such a behavior. As used herein the term “non-cohesive layer” refers to a layer that illustrates no cohesive behavior. The non-cohesive layer is different from a ‘cohesive film’, the latter retains its structural integrity and is peeled as a skin.

As used herein the terms “hydrophobicity” and “hydrophilicity” and the like, may be used in a relative sense, and not necessarily in an absolute sense.

As used herein the term ‘(treatment) formulation’ is meant that the formulation is for use with an intermediate transfer member of a printing system i.e., for use in treating a release surface of an ITM with said formulation e.g., as herein described and exemplified.

Unless stated otherwise, physical properties of a liquid (e.g. treatment formulation) such as viscosity and surface tension, refer to the properties at 25° C.

As used herein, unless stated otherwise, a ‘total percent solids’ of a liquid composition is calculated by multiplying 100 times the weight of residue, after complete drying at 25° C., divided by the weight of initial liquid composition.

Unless otherwise defined, all technical and scientific terms used herein have the same meaning as commonly understood by one of ordinary skill in the art to which the invention pertains. In case of conflict, the specification, including definitions, will take precedence.

In the description and claims of the present disclosure, each of the verbs, “comprise” “include” and “have”, and conjugates thereof, are used to indicate that the object or objects of the verb are not necessarily a complete listing of members, components, elements, steps or parts of the subject or subjects of the verb. These terms encompass the terms “consisting of” and “consisting essentially of”.

As used herein, the singular form “a”, “an” and “the” include plural references and mean “at least one” or “one or more” unless the context clearly dictates otherwise.

Unless otherwise stated, the use of the expression “and/or” between the last two members of a list of options for selection indicates that a selection of one or more of the listed options is appropriate and may be made.

Unless otherwise stated, adjectives such as “substantially” and “about” that modify a condition or relationship characteristic of a feature or features of an embodiment of the present technology, are to be understood to mean that the condition or characteristic is defined to within tolerances that are acceptable for operation of the embodiment for an application for which it is intended.

At times, the term “about” indicates ±10% of the value it refers to.

An x degrees Celsius evaporation load is defined as follows: x is a positive number. When a solution is y % solids wt/wt and z % liquid wt/wt at x degrees Celsius, the ‘x-degrees Celsius evaporation load’ of the solution is that ratio z/y. The units of ‘evaporation load’ are “weight solvent per weight total solute.′ For the present disclosure, evaporation load is always defined at atmospheric pressure. For the present disclosure, a default value of ‘x’ is 60 degrees C.—the term ‘evaporation load’ without a prefix specifying a temperature refers to a 60 degrees Celsius evaporation load at atmospheric pressure.

It is noted that embodiments detailed herein in connection with a certain aspect of the invention are applicable mutatis mutandis to further aspects of the invention.

### DETAILED DESCRIPTION OF EMBODIMENTS

The following examples are not in any way intended to limit the scope of the invention as claimed.

### EXAMPLES

Reference is now made to the following examples, which together with the above descriptions, illustrate the invention in a non-limiting fashion.

### A. Exemplary ITM (Banket) Release Layer

### List of Materials Used

| | | CAS | |
|---|---|---|---|
| Ingredient | Supplier | Number | Description |
| DMS-V35 | Gelest | 68083- | Vinyl terminated polydimethyl |
| Resin | | 19-2 | siloxane |
| | | | Viscosity 5,000 mPa · s |
| | | | MW~49,500 |
| | | | Vinyl~0.018-0.05 mmol/g |
| VQM-146 | Gelest | 68584- | 20-25% Vinyl resin in DMS V46 |
| Resin | | 83-8 | Viscosity 50,000-60,000 mPa · s |
| | | | Vinyl~0.18-0.23 mmol/g |
| Inhibitor 600 | Evonik | 204- | Mix of |
| Cure Retardant | | 070-5 | divinylpolydimethylsiloxane and |
| | | | 2-methylbut-3-yn-2-ol |
| | | | Viscosity 900 mPa · s |
| | | | Vinyl 0.11 mmol/g |
| SIP6831.2 | Gelest | 68478- | Platinum |
| Catalyst | | 92-2 | divinyltetramethyldisiloxane |
| | | | Platinum 2.1-2.4% |
| Polymer | Evonik | | Vinyl-functional polydimethyl |
| RV 5000 | | | siloxanes |
| (XPRV 5000) | | | Viscosity 3000 mPa · s |
| Resin | | | Vinyl 0.4 mmol/g |
| Crosslinker 100 | Evonik | | Polydimethyl siloxanes including |
| Crosslinker | | | SiH groups in the polymer chain |
| | | | Hydride 7.8 mmol/g |
| HMS-301 | Gelest | 68037- | Poly(dimethylsiloxane-co- |
| Crosslinker | | 59-2 | methyl-hydrosiloxane), |
| | | | trimethylsilyl terminated |
| | | | Hydride 4.2 mmol/g |
| Silsurf A010- | Siltech | 134180- | polyether siloxane copolymer |
| D-UP Additive | | 76-0 | |
| SilGrip SR 545 | Momentive | 56275- | Silicone-based resin containing |
| Functional MQ | | 01-5 | “MQ” groups |
| resin | | | Viscosity 11 mPa · s |
| Aluminized | Hanita | NR | Aluminized polyester film |
| PET | Ltd. | | |
| Skyroll SH 92 | SKC Inc. | NR | Anti-static polyester film |
| Skyroll SH 76 | SKC Inc. | NR | Untreated polyester film |

The carriers used as substrates in the production of the release layer surface include an anti-static polyester film (Examples 1-7).

### Example 1

The ITM release layer of Example 1 had the following composition (wt./wt.):

| Name | Parts |
|---|---|
| DMS-V35 | 70 |
| XPRV-5000 | 30 |
| VQM-146 | 40 |
| Inhibitor 600 | 5 |
| SIP6831.2 | 0.1 |
| Crosslinker | 12 |
| HMS-301 | |

The release layer was prepared substantially as described in the present blanket preparation procedure, provided below.

### Blanket Preparation Procedure (for Release Layers Cured Against a Carrier Surface)

All components of the release layer formulation were thoroughly mixed together. The desired thickness of the incipient release layer was coated on a PET sheet, using a rod/knife (other coating methods may also be used), followed by curing for 3 minutes at 150° C. Subsequently, Siloprene LSR 2530 was coated on top of the release layer, using a knife, to achieve a desired thickness. Curing was then performed at 150° C. for 3 minutes. An additional layer of Siloprene LSR 2530 was then coated on top of the previous (cured) silicone layer, and fiberglass fabric was incorporated into this wet, fresh layer such that wet silicone penetrated into the fabric structure. Curing was then performed at 150° C. for 3 minutes. A final layer of Siloprene LSR 2530 was then coated onto the fiberglass fabric and, once again, curing was performed at 150° C. for 3 minutes. The integral blanket structure was then cooled to room temperature and the PET was removed.

### Example 2

The ITM release layer of Example 2 has the following composition:

| Component Name | Parts |
|---|---|
| DMS-V35 | 70 |
| XPRV-5000 | 30 |
| VQM-146 | 40 |
| Inhibitor 600 | 5 |
| SIP6831.2 | 0.1 |
| Crosslinker HMS-301 | 12 |
| Silsurf A010-D-UP | 5 |

The blanket was prepared substantially as described in Example 1.

### Example 3

The ITM release layer of Example 3 has the following composition:

| Component Name | Parts |
|---|---|
| DMS-V35 | 70 |
| XPRV-5000 | 30 |
| VQM-146 | 40 |
| Inhibitor 600 | 5 |
| SIP6831.2 | 0.1 |
| Crosslinker 100 | 6.5 |
| Silsurf A010-D-UP | 5 |

The blanket was prepared substantially as described in Example 1.

### Example 4

The ITM release layer of Example 4 has the following composition:

| Component Name | Parts |
|---|---|
| DMS-V35 | 100 |
| VQM-146 | 40 |
| Inhibitor 600 | 3 |
| SIP6831.2 | 0.1 |
| Crosslinker HMS-301 | 5 |

The blanket was prepared substantially as described in Example 1.

### Example 5

The ITM release layer of Example 5 was prepared from Silopren® LSR 2530 (Momentive Performance Materials Inc., Waterford, NY), a two-component liquid silicone rubber, in which the two components are mixed at a 1:1 ratio. The blanket was prepared substantially as described in Example 1.

### Example 6

The ITM release layer of Example 6 has a composition that is substantially identical to that of Example 4, but includes SR545 (Momentive Performance Materials Inc., Waterford, NY), a commercially available silicone-based resin containing polar groups. The polar groups are of the “MQ” type, where “M” represents Me₃SiO and “Q” represents SiO₄. The full composition is provided below:

| Component Name | Parts |
|---|---|
| DMS-V35 | 100 |
| VQM-146 | 40 |
| SR545 | 5 |
| Inhibitor 600 | 3 |
| SIP6831.2 | 0.1 |
| Crosslinker HMS-301 | 5 |

The blanket was prepared substantially as described in Example 1.

### Example 7

The ITM release layer of Example 7 has a composition that is substantially identical to that of Example 6, but includes polymer RV 5000, which includes vinyl-functional polydimethyl siloxanes having a high density of vinyl groups, as described hereinabove. The full composition is provided below:

| Component Name | Parts |
|---|---|
| DMS-V35 | 70 |
| RV 5000 | 30 |
| VQM-146 | 40 |
| Inhibitor 600 | 5 |
| SIP6831.2 | 0.1 |
| Crosslinker HMS-301 | 12 |
| SR545 | 5 |

The blanket was prepared substantially as described in Example 1.

### B. Treatment Formulation

### List of Materials Used for Treatments Below

| | | | | Chemical |
|---|---|---|---|---|
| | | | | Name/ |
| Ingredient | Supplier | Function | Class | Description |
| Methocel ® | DOW | binder | Hydroxymethyl | hydroxypropyl |
| K-3 | | | propylcellulose | substituted |
| Premium LV | | | | methyl |
| | | | | cellulose, 19- |
| | | | | 24% methoxyl |
| | | | | substitution, 7- |
| | | | | 12% |
| | | | | hydroxypropyl |
| | | | | substitution, |
| | | | | 2.4-3.6 cps |
| | | | | viscosity |
| Byk ® Ipx | BYK ® | surfactant | Silicone | Polyether- |
| 23289 | | | surfactant | modified |
| | | | | polydimethylsil |
| | | | | oxane |
| Loxanol ® | BASF | wetting | poly- | Polypropylene |
| PL 5060 | Australia | agent | ethylenimine | glycol alkyl |
| | Ltd. | | | phenyl ether |
| | | | | (CAS Number: |
| | | | | 9064-13-5) |
| Pluronic | BASF | plasticizer/ | non-ionic | Poly(propylene |
| 10R5 | | surfactant | surfactant | glycol)-block- |
| | | | | poly(ethylene |
| | | | | glycol)-block- |
| | | | | poly(propylene |
| | | | | glycol) |
| | | | | (CAS |
| | | | | Number :9003- |
| | | | | 11-6) |
| Disponil | BASF | surfactant | non-ionic | Aqueous |
| APG 215 | | | surfactant | solution based |
| | | | | on: Alkyl |
| | | | | polyglycoside |
| | | | | C8-10 |
| | | | | (CAS Number: |
| | | | | 68515-73-1) |
| Dynol 360 | Evonic | surfactant | non-ionic | Thioether |
| | | | surfactant | (CAS Number: |
| | | | | 928768-73-4) |
| Dynol 604 | Evonic | surfactant | non-ionic | Ethoxylated |
| | | | surfactant | Acetylenic |
| | | | | Diols |
| | | | | (CAS Number: |
| | | | | 169117-72-0) |
| Surfinol 465 | Evonic | surfactant | non-ionic | Ethoxylated |
| | | | surfactant | 2,4,7,9- |
| | | | | tetramethyl 5 |
| | | | | decyn-4,7-diol |
| | | | | (CAS Number: |
| | | | | 9014-85-1) |
| Sugar | | | Humectant | |
| (disaccharide) | | | | |
| Tween ® 20 | Sigma- | surfactant | non-ionic | PEG-20 sorbitan |
| | Aldrich | | surfactant | monolaurate |
| Mergal ® | Troy | anti- | | 2-bromo-2-nitro- |
| K12N | Inter- | microbial | | 1,3-propanediol |
| | national | | | |
| water | | | | DI water |

The following treatment formulations were prepared:

### Example 8A—Formulation A—Formulation of the Invention—the Formulation being Devoid of a Cohesive Water-Soluble Polymer

| Components | Concentration w/w % |
|---|---|
| BYK 23289 | 3.82 |
| Loxanol MI 6730 | 0.2 |
| Sugar | 9.60 |
| Tween 20 | 24.01 |
| Mergal K12N | 0.20 |
| Water | 62.17 |
| % solids | 37.83% |

### Example 8B—A Comparative Example—Formulation B—Known Formulation—The Formulation Including a Cohesive Water-Soluble Polymer (Binder)

The formulation was prepared with the water-soluble polymer Methocel K3 and the content of the ingredients thereof was adjusted to have the same viscosity as the treatment formulation of Example 8A.

| Components | Concentration w/w % |
|---|---|
| BYK 23289 | 2.00 |
| Loxanol MI 6730 | 0.23 |
| Sugar | 5.85 |
| Tween 20 | 14.80 |
| Mergal K12N | 0.20 |
| Methocel K3 (Binder) | 3.38 |
| Water | 73.54 |

The dry behavior of the treatment formulation of the present invention (Formulation A, Example 8A) and the known treatment formulation (Formulation B, Example 8B) was tested.

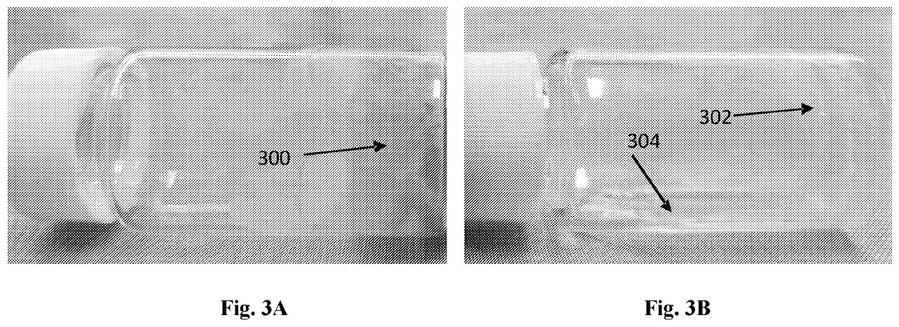

Solution samples of both formulations were heated overnight at 90° C. After heating, the known formulation (prior art) was completely a dry substance (solid state) while the formulation of the present invention formed two phases, dry one (solid phase) and liquid one. This is clearly illustrated in FIG. 3A and FIG. 3B. The known formulation (Formulation B, Example 8B) in the vial presented in FIG. 3A provided upon drying a solid phase (300) with no liquid phase, as illustrated by the arrow in the figure. The treatment formulation of the present invention (Formulation A, Example 8A) in the vial presented in FIG. 3B provided upon drying a solid phase (302) (shown at the bottom of the vial) as illustrated by the arrow in the figure, and a liquid phase (304) (which once the vial was tilted in 90° it flow to the side of the vial), as illustrated by the arrow in the figure.

Without wishing to be bound by theory, the inventors believe that the liquid phase (304) observed in FIG. 3B is an oil phase which is not volatile at the printing process temperature of the present invention. The liquid oil phase may be originated from one of the ingredients of the treatment formulation for example from the surfactant e.g., Tween 20. The formation of a solid phase (at times semisolid phase) and a liquid phase upon drying is referred to herein as sweating phenomenon. This phenomenon is visualized in the vial in FIG. 3B and was also inspected by utilizing a tissue paper that is capable of absorbing the liquid phase. A tissue paper placed onto the dry treatment formulation known in the art (FIG. 3A) remained dry while a tissue paper placed onto the dry treatment formulation of the invention (FIG. 3B) became wet, indicating a sweating phenomenon in the dry treatment formulation of the present invention.

### Example 8C—Formulation C—Formulation of the Invention—The Formulation being Devoid of a Cohesive Water-Soluble Polymer as Well as a Silicon Containing Surfactant

| Components | Concentration w/w % |
|---|---|
| Pluronic 10R5 | 8.1 |
| Disponil APG 215 | 11.6 |
| Loxanol MI 6730 | 0.2 |
| Sugar | 7.7 |
| Dynol 360 | 3.90 |
| Tween 20 | 2.5 |
| Mergal K12N | 0.20 |
| Water | 65.8 |
| % solids | 34.2% |

Furter formulations based on the above formulation were prepared as follows:
Formulation C without Dynol 360 (Formulation E);
Formulation C with 14.7 w/w % Pluronic 10R5, 8.8 w/w % Disponil APG 215, and without Dynol 360 (Formulation F).

### Example 8D—Formulation D—Formulation of the Invention—The Formulation being Devoid of a Cohesive Water-Soluble Polymer as Well as a Silicon Containing Surfactant

| Components | Concentration w/w % |
|---|---|
| Pluronic 10R5 | 14.7 |
| Disponil APG 215 | 8.8 |
| Loxanol MI 6730 | 0.29 |
| Sugar | 8.8 |
| Tween 20 | 5.9 |
| Mergal K12N | 0.20 |
| Water | 61.31 |
| % solids | 38.51% |

### Example 8E—Further Formulations of the Invention—The Formulations being Devoid of a Cohesive Water-Soluble Polymer as Well as a Silicon Containing Surfactant

Further formulations were prepared at various concentration ranges of the components as noted below:

| Components | Concentration w/w % |
|---|---|
| Pluronic 10R5 | 8.0-15.0 |
| Disponil APG 215 | 8.0-11.6 |
| Loxanol MI 6730 | 0.2 |
| Sugar | 7.7 |
| Dynol 360 | 0-5 |
| Tween 20 | 2.5 |
| Mergal K12N | 0.20 |
| Water | Complete to 100% total |
| % solids | ~29-34% |

### Example 9—Testing the Transparency of the Treatment Formulations

The transparency of the treatment formulations of the invention was tested and compared to a treatment formulation known in the art. Specifically, the color of the solution state of the treatment Formulations A and C of the present invention was compared to that of the known treatment Formulation B.

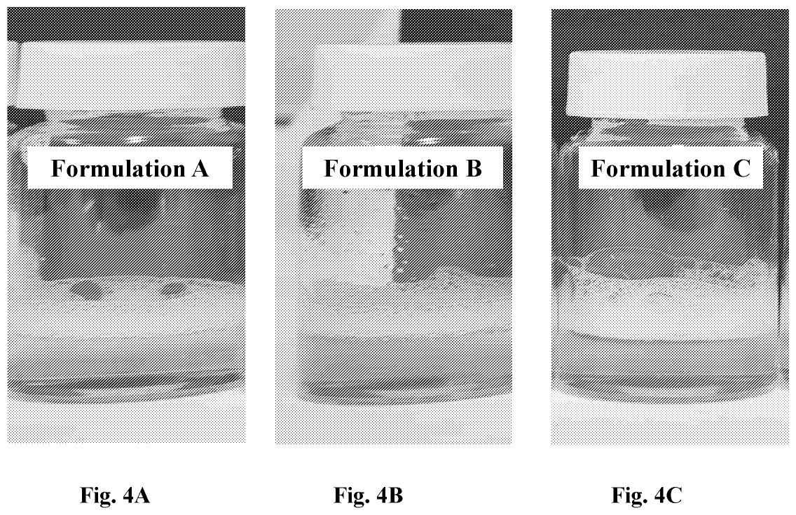

FIGS. 4A-4C display photographs of vials containing solutions of treatment Formulations A and C of the invention (FIG. 4A and FIG. 4C, respectively) in comparison with known treatment Formulation B (FIG. 4B). It is clear from the figures that the solution of know Formulation B which comprises a binder (a cohesive water-soluble polymer) is colored (yellow colored, not shown in grey scale), with reduced color of the solution of Formulation A of the invention that is devoid of a binder. Formulation C which is devoid of both a binder and a silicon containing surfactant is a colorless solution.

Further formulations with the following non-ionic and non-silicone surfactants, alone and in various combinations with each other, were tested: Tween 20, Pluronic 10R5, Disponil APG 215, Dynol 360, Dynol 604 and Surfinol 465. All provided clear colorless transparent treatment formulation.

Exemplary concentrations of the tested surfactants is detailed below:

| Surfactant | Concentration w/w % |
|---|---|
| Pluronic 10R5 | 8.0-15.0 |
| Disponil APG 215 | 8.0-11.6 |
| Dynol 360 | 0-5 |
| Tween 20 | 2.5-24 |

### Example 10—Testing the Ink Dot Size and the Ink Dot Aspect Ratio

The ink drop diameter printed on a coated paper (burgo 130 gsm) utilizing black and magenta inks in a printing process that utilized the treatment Formulations A to C was measured.

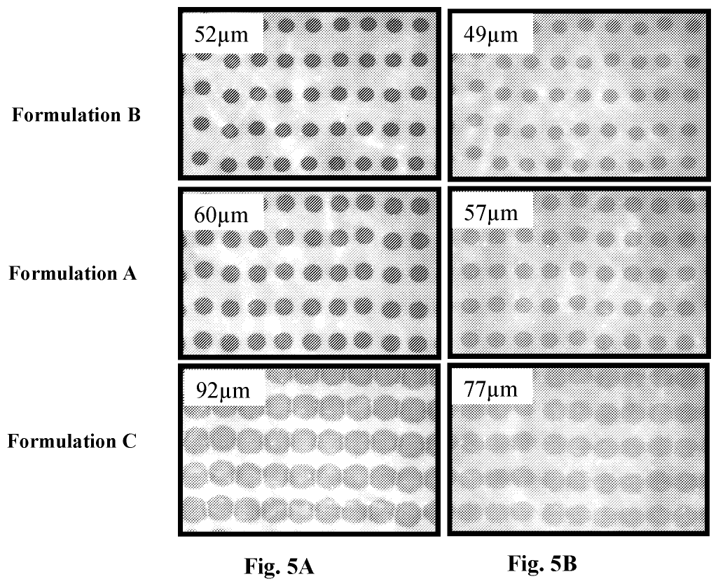

FIGS. 5A-5B display the images of printed dots with black and magenta inks (FIG. 5A and FIG. 5B, respectively). The figures further detail the measured diameter of the ink drops for each tested Formulations A, B and C.

As can be seen from FIGS. 5A-5B, the printing dot utilizing the known treatment Formulation B (with a binder and a silicone surfactant) has smallest diameter in both black and magenta inks e.g., 8 microns lower in diameter than treatment Formulation A of the invention (free of a binder), for black ink. Formulation C of the invention (free of a binder and free of a silicon surfactant) has the largest drop diameter, 40 micron larger in diameter than Formulation B, for black ink.

It is noted that an aspect ratio that was measured for the ink obtained with Formulation A of the invention was 105.587±8.789 (for black ink) and an Aspect ratio that was measured for the ink obtained with Formulation C of the invention was 177.066±20.710 (for black ink).

Further standard black ink formulations were tested, providing aspect ratio values of 300, 363.54 and 371.61 (data not shown).

### Example 11—Testing the Graininess of the Printed Ink Image

The graininess behavior of ink images as a function of the % ink coverage was measured utilizing the PIAS II, QEA machine, the latter calculated graininess according to the ISO-13660 International Print Quality protocol, which uses a tile size of 42.3 μm (See www.qea.com/products/image-analysis/pias-ii).

Specifically, black and magenta inks were used in a printing process that utilized the treatment Formulations A to C.

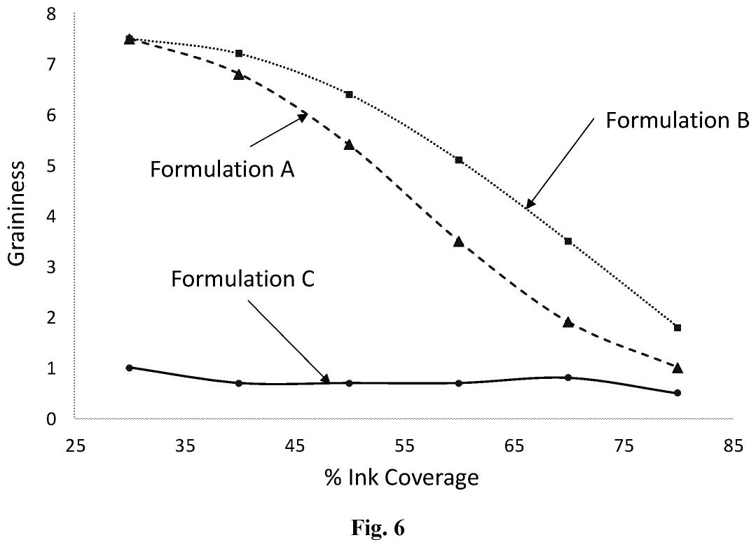

FIG. 6 displays the graininess vs % coverage of magenta ink as observed with treatment Formulations A, B and C.

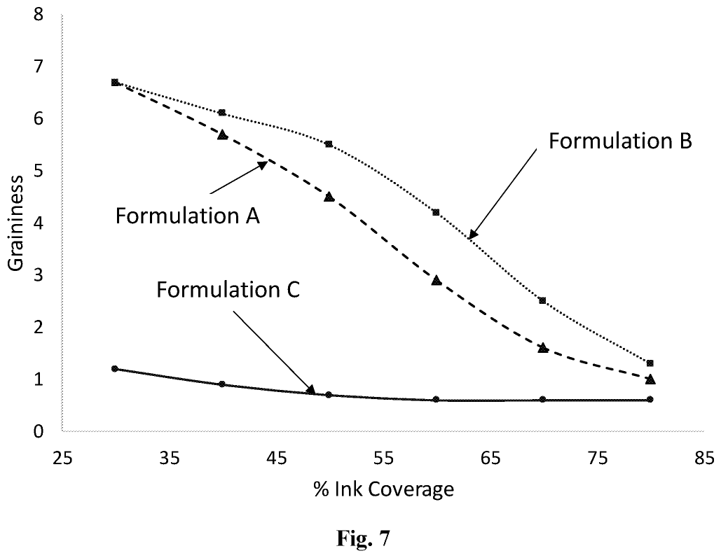

FIG. 7 displays the graininess vs % coverage of black ink as observed with treatment Formulations A, B and C.

It is clear from FIG. 6 and FIG. 7 that treatment Formulation C is better in graininess at 30-80% of ink coverage than treatment Formulation A and the known treatment Formulation B, the latter having the grainiest results. This is reflected in the flat curve graininess behavior (the graininess at 30% coverage is 1.0 and is 0.5 at 80% coverage for magenta ink (FIG. 6) and for black ink the graininess at 30% coverage is 1.2 and is 0.6 at 80% coverage (FIG. 7).

Without wishing to be bound by theory, the inventors of the present invention believe that treatment Formulation C which is free of a silicone surfactant provides better wetting compared to treatment formulations that include a silicon surfactant. Better wetting provides a bigger ink dot and hence provides improved graininess behavior. Improvement in the graininess behavior is advantageous e.g., in terms of printing uniformity that provides cleaner and uniform ink coverage with less non wetting areas, better coverage of problematic print heads such as scratches and more.

### Example 12—Testing the Transfer Behavior of the Ink

The transfer of the ink from the intermediate transfer member (ITM) to the final printed substrate was tested with treatment Formulation A of the invention and with treatment Formulation C of the invention. The ink was transfer to uncoated paper 140 gsm.

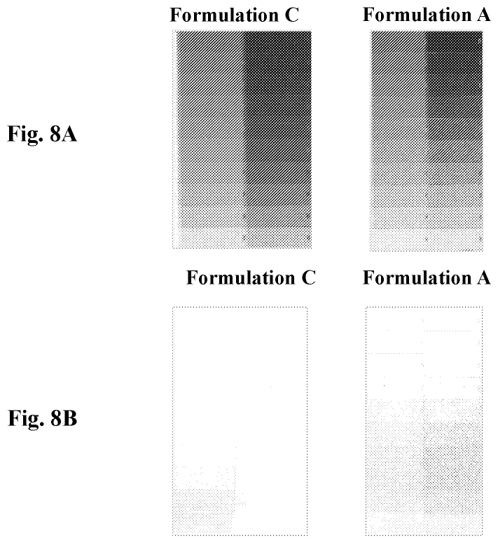

FIG. 8A display the printed images on the uncoated paper 140 gsm with magenta ink (left side of the image, color not shown) and with black ink (right side of the image) observed with Formulations A and C as indicated in the figure. FIG. 8B display the corresponding ink leftover on the intermediate transfer member. While both formulations illustrated good transfer of the ink from the ITM to the paper substrate, Formulation C illustrated a better transfer. This can be clearly seen from the very little amount of the leftovers on the ITM for Formulation C in FIG. 8B. Similar results were observed with inks of different colors (data not shown).

### C. Exemplary Ink Composition

### Preparation of Pigments

Pigments used in the examples described below are generally supplied with initial particle size of a few micrometers. Such pigments were ground to submicron range in presence of the dispersing agent, the two materials being fed to the milling device (bead mill) as an aqueous mixture. The progress of milling was controlled on the basis of particle size measurements (for example, a Malvern or Nanosizer instrument). The milling was stopped when the average particle size (d_{V}50) reached 70 to 100 nm.

In the present example, the preparation of an ink composition is described: Heliogen® Blue D7079 was milled with Disperbyk® 190, as described, and the materials were mixed in the following proportion:

| Heliogen ® Blue D7079 | 30 g |
|---|---|
| Disperbyk ® 190 (40%) | 30 g |
| Water | 140 g |
| ======================A | |
| Total | 200 g |

The milled concentrate, now having a D_{V}50 of less than 100 nm, typically between 70 and 100 nm, and was further diluted with 50 g water and extracted from the milling device at ca. 12 wt. % pigment concentration. The millbase concentrate was further processed as below described for the preparation of an ink composition.

In a first stage, 2.4 g of sodium dodecanoate were added to 200 g of the millbase concentrate to yield a millbase. The mixture was stirred to homogeneity (5′ magnetic stirrer at 50 rpm) and incubated at 60° C. for 1 day. The mixture was then left to cool down to ambient temperature.

In a second stage, ink ingredients were added to the millbase as follows:

| | |
|---|---|
| Millbase Concentrate (from stage 1) | 202.4 g |
| Joncryl ® 538 (46.5%) | 154.8 g |
| BYK ® 349 | 5 g |
| BYK ® 333 | 2 g |
| Propylene Glycol | 240 g |
| Water | 595.8 g |
| Total | 1200 g |

The mixture was stirred for 30 minutes at ambient temperature, resulting in an ink-jettable ink composition having a viscosity of less than 10 cP.

Further inks were tested such as yellow, magenta, cyan, black, orange, green and blue.

### ILLUSTRATIVE EMBODIMENTS

The following embodiments are illustrative and not intended to limit the claimed subject matter. Further, the embodiments detailed herein above in connection with other aspects of the invention are considered relevant also to the embodiments detailed herein below mutatis mutandis.

EMBODIMENT 1 A method of indirect printing comprising:
a. providing an intermediate transfer member (ITM) comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°;
b. providing a hydrophilic treatment formulation comprising:
i. a liquid containing water, said liquid containing water making up between about 5% to about 97.5%, by weight, (at times between about 5% to about 95%, by weight) of the hydrophilic treatment formulation;
ii. at least one first non-ionic surfactant (e.g., having a solubility in water of at least about 7%, at 25° C.), optionally wherein said first non-ionic surfactant making up between about 2.5% to about 95%, by weight, (at times between about 5% to about 95%, by weight) of the hydrophilic treatment formulation);
wherein said hydrophilic treatment formulation optionally further comprises one or more of:
iii. at least one second non-ionic surfactant (e.g., having a solubility in water of at least 1%, at 25° C.);
iv. at least one non-polymeric humectant;
v. at least one wetting agent optionally being a first water-soluble polymeric wetting agent; and
vi. at least one antibacterial agent;
wherein said hydrophilic treatment formulation is devoid of a second water-soluble polymer, said second water-soluble polymer being different from the first water-soluble polymeric wetting agent; and
wherein said hydrophilic treatment formulation having the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight;
c. applying the hydrophilic treatment formulation to the silicone-based release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. drying said wet treatment layer (e.g., by keeping the ITM at a temperature sufficient to dry said wet treatment layer for example 90° C. to 130° C., and/or by subjecting said wet treatment layer to a drying process) to thereby form a dried non-cohesive treatment layer from the wet treatment layer on the silicone-based release layer surface, said dried non-cohesive treatment layer optionally having a thickness of at least about 20 nm and at most about 500 nm (at times at most about 450, 400, 350, 300, 250 or 200 nm);
e. depositing droplets of an aqueous ink, said aqueous ink comprising at least one binder and at least one colorant, onto at least a region of the dried non-cohesive treatment layer, to form an ink image on the release layer surface of the silicone-based release layer surface:
f. drying the ink image to leave an ink-image residue on the silicone-based release layer surface; and
g. transferring the ink-image residue onto a printing substrate by pressured contact between the ITM and the printing substrate.

EMBODIMENT 2 The method of EMBODIMENT 1 wherein said hydrophilic treatment formulation is substantially devoid of a cohesive substance and/or a cohesion inducing substance thereby once said hydrophilic treatment formulation is dried on the silicone-based release layer surface of the ITM, it does not form a film layer thereon.

EMBODIMENT 3 The method of EMBODIMENT 1 or 2, wherein when said hydrophilic treatment formulation is subjected to drying (e.g., at a temperature of between about 90° C. to about 130° C., inclusive) it provides a solid material with sweating of a non-volatile liquid oil (i.e., the resulted dry treatment formulation separates into two phases, a dry solid phase and an oily liquid phase, the latter may comprise traces of water and/or another hydrophilic liquid).

EMBODIMENT 4 The method of any one of EMBODIMENTS 1 to 3, wherein said liquid containing water is water only or a mixture of water and at least one water soluble organic solvent (e.g., ethanol and the like).

EMBODIMENT 5 The method of any one of EMBODIMENTS 1 to 4, wherein said hydrophilic treatment formulation further comprises at least one first water-soluble polymeric wetting agent.

EMBODIMENT 6 The method of EMBODIMENT 5, wherein said first water-soluble polymeric wetting agent is a multiple charged polymer e.g., a polycation or a polyanion.

EMBODIMENT 7 The method of EMBODIMENT 6, wherein said polycation is selected from the group consisting of polyethyleneimine (PEI), poly (amidoamine) (PAMAM), poly-l-lysine (PLL) and poly (diallyl dimethyl ammonium) (PDDA).

EMBODIMENT 8 The method of EMBODIMENT 6, wherein said polyanion is selected from the group consisting of acrylic polymers, polyacryl amides and poly-DADMAc.

EMBODIMENT 9 The method of EMBODIMENT 5, wherein said first water-soluble polymeric wetting agent is PEI.

EMBODIMENT 10 The method of any one of EMBODIMENTS 1 to 9, wherein apart from said first water-soluble polymeric wetting agent e.g., polyethyleneimine, said hydrophilic treatment formulation is devoid of a substance with a molecular weight being of about 1300 gr/mol and above.

EMBODIMENT 11 The method of any one of EMBODIMENTS 1 to 10, wherein said second water-soluble polymer is a cohesive substance and/or a cohesion inducing substance.

EMBODIMENT 12 The method of any one of EMBODIMENTS 1 to 11, wherein said second water-soluble polymer is a water absorbing polymeric agent.

EMBODIMENT 13 The method of any one of EMBODIMENTS 1 to 12, wherein said hydrophilic treatment formulation is further devoid of one or more of an inorganic salt, an inorganic metallic compound (e.g., Magnesium Nitrate Hexahydrate), a polyvalent metal ion and a metal ion.

EMBODIMENT 14 The method of any one of EMBODIMENTS 1 to 13, wherein said hydrophilic treatment formulation is further devoid of an acid e.g., an organic acid.

EMBODIMENT 15 The method of any one of EMBODIMENTS 1 to 14, wherein said hydrophilic treatment formulation is further devoid of a resolubilizing agent.

EMBODIMENT 16 The method of any one of EMBODIMENTS 1 to 15, wherein said hydrophilic treatment formulation is devoid of one or more of the ingredients detailed in any one of EMBODIMENTS 2 and 10 to 15, or any combination thereof.

EMBODIMENT 17 The method of any one of EMBODIMENTS 1 to 16, wherein the total percent solids by weight of the hydrophilic treatment formulation is at least about 5%, or between about 5% to about 95% (inclusive), in particular between about 27% to about 95% (inclusive), even more particular between about 35% to about 95% (inclusive).

EMBODIMENT 18 The method of any one of EMBODIMENTS 1 to 17, wherein said hydrophilic treatment formulation having a 60° C. evaporation load of at least about 1.86:1 by weight.

EMBODIMENT 19 The method of any one of EMBODIMENTS 1 to 18, wherein said first non-ionic surfactant is a silicon containing surfactant or a non-silicon containing surfactant (e.g., polysorbate 20 i.e., Tween 20).

EMBODIMENT 20 The method of any one of EMBODIMENTS 1 to 19, wherein said second non-ionic surfactant is a silicon containing surfactant (e.g., BYK LPX 23289) or a non-silicon containing surfactant.

EMBODIMENT 21 The method of any one of EMBODIMENTS 1 to 20, wherein said second non-ionic surfactant making up at most 10%, by weight. (inclusive) of said hydrophilic treatment formulation.

EMBODIMENT 22 The method of any one of EMBODIMENTS 1 to 21, wherein said hydrophilic treatment formulation further comprises at least one wetting agent (e.g., polyethyleneimine), said wetting agent (e.g., polyethyleneimine) making up at most about 1%, by weight, of said hydrophilic treatment formulation, in particular at most about 0.20%, more particular 0.20% of said hydrophilic treatment formulation.

EMBODIMENT 23 The method of any one of EMBODIMENTS 1 to 22, wherein said non-polymeric humectant (e.g., sorbitol, xylitol, a monosaccharide, a disaccharide) making up at most about 30%, by weight, of said hydrophilic treatment formulation.

EMBODIMENT 24 The method of any one of EMBODIMENTS 1 to 23, wherein said antibacterial agent (e.g., K12N or any other antibacterial agent known in the art) making up at most about 1%, by weight, of said hydrophilic treatment formulation.

EMBODIMENT 25 The method of any one of EMBODIMENTS 1 to 24, wherein the ingredients of said hydrophilic treatment formulation are compatible with each other and with the liquid containing water.

EMBODIMENT 26 The method of any one of EMBODIMENTS 1 to 25, wherein said hydrophilic treatment formulation being a stable solution with no phase separation and with no sedimentation/precipitation at 25° C.

EMBODIMENT 27 The method of any one of EMBODIMENTS 1 to 26, wherein said hydrophilic treatment formulation being a clear colorless solution at 25° C.

EMBODIMENT 28 The method of any one of EMBODIMENTS 1 to 27, wherein the ingredients of said hydrophilic treatment formulation do not form aggregates with the colorant of said aqueous ink.

EMBODIMENT 29 The method of any one of EMBODIMENTS 1 to 28, wherein in step (g), to some extent, the dry non-cohesive treatment layer, in both printed and non-printed regions on the ITM, is transferred to the printing substrate, together with the ink-image residue, leaving a residual dry non-cohesive treatment layer on the ITM.

EMBODIMENT 30 The method of EMBODIMENT 29, wherein said method comprises several repeating cycles of steps (c) to (g) (e.g., 1000 cycles), and wherein between each cycle the newly applied hydrophilic treatment formulation in step (c) completely dissolves said residual dry non-cohesive treatment layer of the previous cycle, thereby no accumulation of residual dry non-cohesive treatment layer between each of said cycles occurs.

EMBODIMENT 31 The method of any one of EMBODIMENTS 1 to 30, wherein when said droplets of said aqueous ink are deposited onto the dry non-cohesive treatment layer, a surface of said dry non-cohesive treatment layer, which is in close contact with said aqueous ink, is capable of dissolving into said aqueous ink and/or mix and/or blend with said aqueous ink optionally forming an intermediate phase comprising one or more ingredients of said hydrophilic treatment formulation and the ink ingredients.

EMBODIMENT 32 The method of EMBODIMENTS 1 to 31, wherein the ink-image residue further comprises one or more ingredients of said hydrophilic treatment formulation (e.g., a liquid oil originated from the treatment formulation and/or at least one solid ingredient).

EMBODIMENT 33 The method of any one of EMBODIMENTS 1 to 32, wherein the ink-image residue is free of aggregates.

EMBODIMENT 34 A system for indirect printing, the system comprising:
a. an intermediate transfer member (ITM) comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°;
b. a quantity of a hydrophilic treatment formulation comprising:
i. a liquid containing water, said liquid containing water making up between about 5% to about 97.5%, by weight, (at times between about 5% to about 95%, by weight) of the hydrophilic treatment formulation;
ii. at least one first non-ionic surfactant (e.g., having a solubility in water of at least about 7%, at 25° C.), optionally wherein said first non-ionic surfactant making up between about 2.5% to about 95%, by weight, (at times between about 5% to about 95%, by weight) of the hydrophilic treatment formulation);
wherein said hydrophilic treatment formulation optionally further comprises one or more of:
iii. at least one second non-ionic surfactant (e.g., having a solubility in water of at least 1%, at 25° C.);
iv. at least one non-polymeric humectant;
v. at least one wetting agent optionally being a first water-soluble polymeric wetting agent; and
vi. at least one antibacterial agent;
wherein said hydrophilic treatment formulation is devoid of a second water-soluble polymer, said second water-soluble polymer being different from the first water-soluble polymeric wetting agent; and
wherein said hydrophilic treatment formulation having the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight;
c. a treatment station for applying the hydrophilic treatment formulation to the silicone-based release layer surface of the ITM to form thereon a wet treatment layer optionally having a thickness of at most about 5.0 μm (at times of at most about 4.5, 4.0, 3.5, 3.0, 2.5, 2.0, 1.5 or 1.0 μm);
d. means for subjecting the wet treatment layer to a drying process to form a dried non-cohesive treatment layer from the wet treatment layer on the silicone-based release layer surface, said dried non-cohesive treatment layer optionally having a thickness of at least about 20 nm and at most about 500 nm (at times at most about 450, 400, 350, 300, 250 or 200 nm);
e. at least one ink jet nozzle positioned proximate the intermediate transfer member and configured for jetting aqueous ink droplets, comprising at least one binder and at least one colorant, onto at least a region of the dried non-cohesive treatment layer formed on the intermediate transfer member;
f. a drying station for drying the ink on the dried non-cohesive treatment layer formed on the intermediate transfer member to produce an ink-image residue on the silicone-based release layer surface; and
g. an impression station for transferring the ink-image residue onto a printing substrate by pressured contact between the ITM and the printing substrate.

EMBODIMENT 35 The system of EMBODIMENT 34, for preforming the method of any one of EMBODIMENTS 1 to 33.

EMBODIMENT 36 The system of EMBODIMENT 34 or 35, wherein said the hydrophilic treatment formulation is as disclosed herein above and below.

EMBODIMENT 37 A printed article comprising:
(i) a substrate;
(ii) one or more dry ink dots fixedly adhered to at least a region of a surface of said substrate,
wherein said one or more dry ink dots comprise at least one binder, at least one colorant and one or more of the non-volatile ingredients of the hydrophilic treatment formulations as disclosed herein above and below.

EMBODIMENT 38 The printed article of EMBODIMENT 37, wherein said dry one or more ink dots are further covered with a dry non-cohesive layer (non film layer) comprising one or more of the non-volatile ingredients of the hydrophilic treatment formulations as disclosed herein above and below.

EMBODIMENT 39 The printed article of EMBODIMENT 37 or 38, wherein non printed regions of said substrate are covered with a dry non-cohesive layer (non-film layer) comprising one or more of the non-volatile ingredients of the hydrophilic treatment formulations as disclosed herein above and below.

EMBODIMENT 40 The printed article of any one of EMBODIMENTS 37 to 39, produced according to the method of any one of EMBODIMENTS 1 to 33.

EMBODIMENT 41 An intermediate transfer member (ITM) comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°,
wherein said surface is substantially covered with a dry non-cohesive layer (non-film layer) comprising one or more of the ingredients hydrophilic treatment formulations as disclosed herein above and below, and optionally wherein the thickness of said dry non-cohesive layer (non-film layer) being of at least about 20 nm and at most about 500 nm (at times at most about 450, 400, 350, 300, 250 or 200 nm).

EMBODIMENT 42 The intermediate transfer member of EMBODIMENT 41, wherein the dry non-cohesive layer (non-film layer) is a sweating non-cohesive layer comprising a solid material phase and a non-volatile liquid oil phase.

EMBODIMENT 43 The intermediate transfer member of EMBODIMENT 41 or 42, wherein the dry non-cohesive layer (non-film layer) covers at least 50% or at least 75% or at least 90% or at least 95% at least 95% or at least 99% or 100% of the intermediate transfer member release layer surface.

EMBODIMENT 44 An intermediate transfer member (ITM) comprising a release layer surface, wherein said surface is substantially covered with the hydrophilic treatment formulation disclosed herein above and below.

EMBODIMENT 1A A hydrophilic treatment formulation for use with an intermediate transfer member (ITM) of a printing system, the hydrophilic treatment formulation comprising:
i. a liquid containing water, said liquid containing water making up between about 5% to about 95%, by weight, of the hydrophilic treatment formulation;
ii. at least one first non-ionic surfactant;
said hydrophilic treatment formulation optionally further comprises one or more of:
iii. at least one second non-ionic surfactant (e.g., having a solubility in water of at least 1%, at 25° C.);
iv. at least one humectant;
v. at least one wetting agent optionally being a first water-soluble polymeric wetting agent; and
vi. at least one antibacterial agent;
wherein a dry form of said hydrophilic treatment formulation is a non-cohesive form of a solid material sweated with a non-volatile liquid oil.

EMBODIMENT 2A The hydrophilic treatment formulation of EMBODIMENT 1A, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

EMBODIMENT 3A The hydrophilic treatment formulation of EMBODIMENT 1A or EMBODIMENT 2A, wherein said hydrophilic treatment formulation having the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight.

EMBODIMENT 4A The hydrophilic treatment formulation of any one of EMBODIMENTS 1A to 3A, wherein said hydrophilic treatment formulation is devoid of a second water-soluble polymer, said second water-soluble polymer being different from the first water-soluble polymeric wetting agent.

EMBODIMENT 5A The hydrophilic treatment formulation of EMBODIMENT 4A, wherein said second water-soluble polymer is a cohesive substance and/or a cohesion inducing substance.

EMBODIMENT 6A The hydrophilic treatment formulation of EMBODIMENT 5A, wherein said second water-soluble polymer is a water absorbing polymeric agent.

EMBODIMENT 7A The hydrophilic treatment formulation of any one of EMBODIMENTS 1A to 6A, wherein said hydrophilic treatment formulation is substantially devoid of a cohesive substance and/or a cohesion inducing substance.

EMBODIMENT 8A The hydrophilic treatment formulation of any one of EMBODIMENTS 1A to 7A, wherein said liquid containing water is water only or a mixture of water and at least one water soluble organic solvent (e.g., ethanol and the like).

EMBODIMENT 9A The hydrophilic treatment formulation of any one of EMBODIMENTS 1A to 8A, wherein said hydrophilic treatment formulation further comprises at least one first water-soluble polymeric wetting agent.

EMBODIMENT 10A The hydrophilic treatment formulation of any one of EMBODIMENTS 1A to 9A, wherein said first water-soluble polymeric wetting agent is a multiple charged polymer e.g., a polycation or a polyanion.

EMBODIMENT 11A The hydrophilic treatment formulation of EMBODIMENT 10A, wherein said polycation is selected from the group consisting of polyethyleneimine (PEI), poly (amidoamine) (PAMAM), poly-l-lysine (PLL) and poly (diallyl dimethyl ammonium) (PDDA).

EMBODIMENT 12A The hydrophilic treatment formulation of EMBODIMENT 10A, wherein said polyanion is selected from the group consisting of acrylic polymers, polyacryl amides and poly-DADMAc.

EMBODIMENT 13A The hydrophilic treatment formulation of EMBODIMENT 10A, wherein said first water-soluble polymeric wetting agent is PEI.

EMBODIMENT 14A The hydrophilic treatment formulation of any one of EMBODIMENTS 1A to 13A, wherein apart from said first water-soluble polymeric wetting agent (e.g., polyethyleneimine), said hydrophilic treatment formulation is devoid of a substance with a molecular weight being of about 1300 gr/mol and above.

EMBODIMENT 15A The hydrophilic treatment formulation of any one of EMBODIMENTS 1A to 14A, wherein said hydrophilic treatment formulation is further devoid of one or more of an inorganic salt, an inorganic metallic compound (e.g., Magnesium Nitrate Hexahydrate), a polyvalent metal ion and a metal ion.

EMBODIMENT 16A The hydrophilic treatment formulation of any one of EMBODIMENTS 1A to 15A, wherein said hydrophilic treatment formulation is further devoid of an acid e.g., an organic acid.

EMBODIMENT 17A The hydrophilic treatment formulation of any one of EMBODIMENTS 1A to 16A, wherein said hydrophilic treatment formulation is further devoid of a resolubilizing agent.

EMBODIMENT 18A The hydrophilic treatment formulation of any one of EMBODIMENTS 1A to 17A, wherein said hydrophilic treatment formulation is devoid of one or more of the ingredients detailed in any one of EMBODIMENTS 4A to 7A and EMBODIMENTS 14A to 17A or any combination thereof.

EMBODIMENT 19A The hydrophilic treatment formulation of any one of EMBODIMENTS 1A to 18A, wherein the total percent solids by weight of the hydrophilic treatment formulation is at least about 5%, or between about 5% to about 95% (inclusive), in particular between about 27% to about 95% (inclusive), even more particular between about 35% to about 95% (inclusive).

EMBODIMENT 20A The hydrophilic treatment formulation of any one of EMBODIMENTS 1A to 19A, wherein said hydrophilic treatment formulation having a 60° C. evaporation load of at least about 1.86:1 by weight.

EMBODIMENT 21A The hydrophilic treatment formulation of any one of EMBODIMENTS 1A to 20A, wherein said first non-ionic surfactant has a solubility in water of at least about 7%, at 25° C.

EMBODIMENT 22A The hydrophilic treatment formulation of any one of EMBODIMENTS 1A to 21A, wherein said first non-ionic surfactant makes up between about 5% to about 95%, by weight, of the hydrophilic treatment formulation.

EMBODIMENT 23A The hydrophilic treatment formulation of any one of EMBODIMENTS 1A to 22A, wherein said first non-ionic surfactant is a silicon containing surfactant or a non-silicon containing surfactant (e.g., polysorbate 20 i.e., Tween 20).

EMBODIMENT 24A The hydrophilic treatment formulation of any one of EMBODIMENTS 1A to 23A, wherein said second non-ionic surfactant has a solubility in water of at least 1%, at 25° C.

EMBODIMENT 25A The hydrophilic treatment formulation of any one of EMBODIMENTS 1A to 24A, wherein said second non-ionic surfactant is a silicon containing surfactant (e.g., BYK LPX 23289) or a non-silicon containing surfactant.

EMBODIMENT 26A The hydrophilic treatment formulation of any one of EMBODIMENTS 1A to 25A, wherein said second non-ionic surfactant making up at most 10%, by weight, (inclusive) of said hydrophilic treatment formulation.

EMBODIMENT 27A The hydrophilic treatment formulation of any one of EMBODIMENTS 1A to 26A, wherein said hydrophilic treatment formulation further comprises at least one wetting agent (e.g., polyethyleneimine), said wetting agent (e.g., polyethyleneimine) making up at most about 1%, by weight, of said hydrophilic treatment formulation, in particular at most about 0.20%, more particular 0.20% of said hydrophilic treatment formulation.

EMBODIMENT 28A The hydrophilic treatment formulation of any one of EMBODIMENTS 1A to 27A, wherein said humectant making up at most about 30%, by weight, of said hydrophilic treatment formulation.

EMBODIMENT 29A The hydrophilic treatment formulation of any one of EMBODIMENTS 1A to 28A, wherein said at least one humectant is a non-polymeric humectant.

EMBODIMENT 30A The hydrophilic treatment formulation of any one of EMBODIMENTS 1A to 29A, wherein said antibacterial agent making up at most about 1%, by weight, of said hydrophilic treatment formulation.

EMBODIMENT 31A The hydrophilic treatment formulation of any one of EMBODIMENTS 1A to 30A, wherein:
said first non-ionic surfactant making up between about 5% to about 95%, by weight, of the hydrophilic treatment formulation;
said second non-ionic surfactant making up at most 10%, by weight, (inclusive) of said hydrophilic treatment formulation;
said wetting agent (e.g., polyethyleneimine) making up at most about 1%, by weight, of said hydrophilic treatment formulation, in particular at most about 0.20%, more particular 0.20% of said hydrophilic treatment formulation;
said humectant making up at most about 30%, by weight, of said hydrophilic treatment formulation; and
said antibacterial agent making up at most about 1%, by weight, of said hydrophilic treatment formulation.

EMBODIMENT 32A The hydrophilic treatment formulation of any one of EMBODIMENTS 1A to 31A, wherein said at least one humectant is a non-polymeric humectant.

EMBODIMENT 33A The hydrophilic treatment formulation of any one of EMBODIMENTS 1A to 32A, wherein the ingredients of said hydrophilic treatment formulation are compatible with each other and with the liquid containing water.

EMBODIMENT 34A The hydrophilic treatment formulation of any one of EMBODIMENTS 1A to 33A, wherein said hydrophilic treatment formulation being a stable solution with no phase separation and with no sedimentation/precipitation at 25° C.

EMBODIMENT 35A The hydrophilic treatment formulation of any one of EMBODIMENTS 1A to 34A, wherein said hydrophilic treatment formulation being a clear colorless solution at 25° C.

EMBODIMENT 36A The hydrophilic treatment formulation of any one of EMBODIMENTS 1A to 35A, wherein the ingredients of said hydrophilic treatment formulation do not form aggregates with the colorant of an aqueous ink utilized in the printing system.

EMBODIMENT 37A A method of indirect printing comprising:
a. providing an intermediate transfer member (ITM) comprising a release layer surface;
b. providing the hydrophilic treatment formulation of any one of EMBODIMENTS 1A to 36A;
c. applying the hydrophilic treatment formulation onto the release layer surface of the ITM to form thereon a wet treatment layer optionally having a thickness of at most about 5.0 μm;
d. drying said wet treatment layer to thereby form a dried non-cohesive sweating treatment layer from the wet treatment layer on the ITM release layer surface, said dried non-cohesive sweating treatment layer optionally having a thickness of at least about 20 nm and at most about 500 nm:
e. depositing droplets of an aqueous ink, said aqueous ink comprising at least one binder and at least one colorant, onto at least a region of the dried non-cohesive sweating treatment layer, to form an ink image on the ITM release layer surface;
f. drying the ink image to leave an ink-image residue on the ITM release layer surface; and
g. transferring the ink-image residue onto a printing substrate by pressured contact between the ITM and the printing substrate.

EMBODIMENT 38A The method of EMBODIMENT 37A, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

EMBODIMENT 39A The method of EMBODIMENT 37A or 38A, wherein said hydrophilic treatment formulation is substantially devoid of a cohesive substance and/or a cohesion inducing substance thereby once said hydrophilic treatment formulation is dried on the release layer surface of the ITM it does not form a film layer thereon.

EMBODIMENT 40A The method of any one of EMBODIMENTS 37A to 39A, wherein said drying in step (d) is performed at a temperature of between about 90° C. to about 130° C., inclusive.

EMBODIMENT 41A The method of any one of EMBODIMENTS 37A to 40A, wherein said dried non-cohesive sweating treatment layer is comprised of a solid material sweated with a non-volatile liquid oil.

EMBODIMENT 42A The method of any one of EMBODIMENTS 37A to 41A, wherein said dried non-cohesive sweating treatment layer is colorless.

EMBODIMENT 43A The method of any one of EMBODIMENTS 37A to 42A, wherein the ingredients of said hydrophilic treatment formulation do not form aggregates with the colorant of said aqueous ink.

EMBODIMENT 44A The method of any one of EMBODIMENTS 37A to 43A, wherein in step (g), to some extent, the dry non-cohesive sweating treatment layer, in both printed and non-printed regions on the ITM, is transferred to the printing substrate, together with the ink-image residue, leaving a residual dry non-cohesive sweating treatment layer on the ITM or a residual dry non-cohesive non-sweating treatment layer on the ITM.

EMBODIMENT 45A The method of any one of EMBODIMENTS 37A to 44A, wherein said method comprises several repeating cycles of steps (c) to (g) (e.g., 1000 cycles), and wherein between each cycle the newly applied hydrophilic treatment formulation in step (c) completely dissolves said residual dry non-cohesive sweating treatment layer or said residual dry non-cohesive non-sweating treatment layer of the previous cycle, thereby no accumulation of said residual layer/s between each of said cycles occurs.

EMBODIMENT 46A The method of any one of EMBODIMENTS 37A to 45A, wherein when said droplets of said aqueous ink are deposited onto the dry non-cohesive sweating treatment layer, a surface of said dry non-cohesive sweating treatment layer, which is in close contact with said aqueous ink, is capable of dissolving into said aqueous ink and/or mix and/or blend with said aqueous ink, optionally forming an intermediate phase comprising one or more ingredients of said hydrophilic treatment formulation and the ink ingredients.

EMBODIMENT 47A The method of any one of EMBODIMENTS 37A to 46A, wherein the ink-image residue further comprises one or more ingredients of said hydrophilic treatment formulation.

EMBODIMENT 48A The method of any one of EMBODIMENTS 37A to 47A, wherein the ink-image residue is free of aggregates.

EMBODIMENT 49A A system for indirect printing, the system comprising:
a. an intermediate transfer member (ITM) comprising a release layer surface;
b. a quantity of the hydrophilic treatment formulation of any one of EMBODIMENTS 1A to 36A;
c. a treatment station for applying the hydrophilic treatment formulation to the release layer surface of the ITM to form thereon a wet treatment layer optionally having a thickness of at most 5.0 μm:
d. means for subjecting the wet treatment layer to a drying process to form a dried non-cohesive sweating treatment layer from the wet treatment layer on the ITM release layer surface, said dried non-cohesive sweating treatment layer optionally having a thickness of at least about 20 nm and at most about 500 nm;
e. at least one ink jet nozzle positioned proximate the intermediate transfer member and configured for jetting aqueous ink droplets, comprising at least one binder and at least one colorant, onto at least a region of the dried non-cohesive sweating treatment layer formed on the intermediate transfer member;
f. a drying station for drying the ink on the dried non-cohesive sweating treatment layer formed on the intermediate transfer member to leave an ink-image residue on the ITM release layer surface; and
g. an impression station for transferring the ink-image residue onto a printing substrate by pressured contact between the ITM and the printing substrate.

EMBODIMENT 50A The system of EMBODIMENT 49A, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

EMBODIMENT 51A The system of EMBODIMENT 49A or 50A, for preforming the method of any one of EMBODIMENTS 37A to 48A.

EMBODIMENT 52A A printed article comprising:
(i) a substrate;
(ii) one or more dry ink dots fixedly adhered to at least a region of a surface of said substrate,
wherein said one or more dry ink dots comprise at least one binder, at least one colorant and one or more of non-volatile ingredients of the hydrophilic treatment formulations of any one of EMBODIMENTS 1A to 36A.

EMBODIMENT 53A The printed article of EMBODIMENTS 52A, wherein said dry one or more ink dots are further covered with a dry non-cohesive sweating layer comprising one or more of the non-volatile ingredients of said hydrophilic treatment formulation.

EMBODIMENT 54A The printed article of EMBODIMENT 52A or 53A, wherein non printed regions of said substrate are covered with a dry non-cohesive sweating layer comprising one or more of the non-volatile ingredients of the hydrophilic treatment formulation.

EMBODIMENT 55A The printed article of any one of EMBODIMENTS 52A to 54A, produced according to the method of any one of EMBODIMENTS 37A to 48A.

EMBODIMENT 56A An intermediate transfer member comprising a release layer surface, wherein said surface is substantially covered with a dry non-cohesive sweating layer comprising one or more of the non-volatile ingredients of the hydrophilic treatment formulation of any one of EMBODIMENTS 1A to 36A, and optionally wherein the thickness of said dry non-cohesive sweating layer being of at least about 20 nm and at most about 500 nm.

EMBODIMENT 57A The intermediate transfer member of EMBODIMENTS 56A, wherein the dry non-cohesive sweating layer covers at least 50% or at least 75% or at least 90% or at least 95% at least 95% or at least 99% or 100% of the intermediate transfer member release layer surface.

EMBODIMENT 58A An intermediate transfer member comprising a release layer surface, wherein said surface is substantially covered with the hydrophilic treatment formulation of any one of EMBODIMENTS 1A to 36A.

EMBODIMENT 59A An intermediate transfer member comprising a release layer surface, wherein said surface is substantially covered with the hydrophilic treatment formulation of any one of EMBODIMENTS 1A to 36A, and wherein when said intermediate transfer member is at a temperature being of between about 90° C. to about 130° C., a dried non-cohesive sweating treatment layer is form thereon, optionally wherein the thickness of said dry non-cohesive sweating layer being of at least about 20 nm and at most about 500 nm.

EMBODIMENT 60A The intermediate transfer member of any one of EMBODIMENTS 56A to 59A, comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

EMBODIMENT 1B A hydrophilic treatment formulation for use with an intermediate transfer member (ITM) of a printing system, the hydrophilic treatment formulation comprising:
i. a liquid containing water, said liquid containing water making up between about 5% to about 97.5%, by weight, of the hydrophilic treatment formulation;
ii. at least one first non-ionic surfactant;
wherein said hydrophilic treatment formulation optionally further comprises one or more of:
iii. at least one second non-ionic surfactant (e.g., having a solubility in water of at least 1%, at 25° C.);
iv. at least one humectant;
v. at least one wetting agent optionally being a first water-soluble polymeric wetting agent; and
vi. at least one antibacterial agent;
wherein a dry form of said hydrophilic treatment formulation is a non-cohesive form of a solid or semisolid material sweated with a non-volatile liquid oil.

EMBODIMENT 2B The hydrophilic treatment formulation of EMBODIMENT 1B, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

EMBODIMENT 3B The hydrophilic treatment formulation of EMBODIMENT 1B or EMBODIMENT 2B, wherein said hydrophilic treatment formulation having the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight.

EMBODIMENT 4B The hydrophilic treatment formulation of any one of EMBODIMENTS 1B to 3B, wherein said hydrophilic treatment formulation is devoid of a second water-soluble polymer, said second water-soluble polymer being different from the first water-soluble polymeric wetting agent and wherein said second water-soluble polymer is a cohesive substance and/or a cohesion inducing substance.

EMBODIMENT 5B The hydrophilic treatment formulation of EMBODIMENT 4B, wherein said second water-soluble polymer is a water absorbing polymeric agent.

EMBODIMENT 6B The hydrophilic treatment formulation of EMBODIMENT 4B, wherein said hydrophilic treatment formulation is substantially devoid of a further cohesive substance and/or a cohesion inducing substance.

EMBODIMENT 7B The hydrophilic treatment formulation of any one of EMBODIMENTS 1B to 6B wherein said hydrophilic treatment formulation is substantially devoid of a film forming agent.

EMBODIMENT 8B The hydrophilic treatment formulation of any one of EMBODIMENTS 1B to 7B, wherein said liquid containing water is water only or a mixture of water and at least one water soluble organic solvent (e.g., ethanol and the like).

EMBODIMENT 9B The hydrophilic treatment formulation of any one of EMBODIMENTS 1B to 8B, wherein said hydrophilic treatment formulation further comprises at least one first water-soluble polymeric wetting agent.

EMBODIMENT 10B The hydrophilic treatment formulation of any one of EMBODIMENTS 1B to 9B, wherein said first water-soluble polymeric wetting agent is a multiple charged polymer e.g., a polycation or a polyanion.

EMBODIMENT 11B The hydrophilic treatment formulation of EMBODIMENT 10B, wherein said polycation is selected from the group consisting of polyethyleneimine (PEI), poly (amidoamine) (PAMAM), poly-l-lysine (PLL) and poly (diallyl dimethyl ammonium) (PDDA).

EMBODIMENT 12B The hydrophilic treatment formulation of EMBODIMENT 10B, wherein said polyanion is selected from the group consisting of acrylic polymers, polyacryl amides and poly-DADMAc.

EMBODIMENT 13B The hydrophilic treatment formulation of EMBODIMENT 10B, wherein said first water-soluble polymeric wetting agent is PEI.

EMBODIMENT 14B The hydrophilic treatment formulation of any one of EMBODIMENTS 1B to 13B, wherein apart from said first water-soluble polymeric wetting agent (e.g., polyethyleneimine) and/or said at least one first non-ionic surfactant, said hydrophilic treatment formulation is devoid of a substance with a molecular weight being of about 1300 gr/mol and above.

EMBODIMENT 15B The hydrophilic treatment formulation of any one of EMBODIMENTS 1B to 14B, wherein said hydrophilic treatment formulation is further devoid of one or more of an inorganic salt, an inorganic metallic compound (e.g., Magnesium Nitrate Hexahydrate), a polyvalent metal ion and a metal ion.

EMBODIMENT 16B The hydrophilic treatment formulation of any one of EMBODIMENTS 1B to 15B, wherein said hydrophilic treatment formulation is further devoid of an acid e.g., an organic acid.

EMBODIMENT 17B The hydrophilic treatment formulation of any one of EMBODIMENTS 1B to 16B, wherein said hydrophilic treatment formulation is further devoid of a resolubilizing agent.

EMBODIMENT 18B The hydrophilic treatment formulation of any one of EMBODIMENTS 1B to 17B, wherein said hydrophilic treatment formulation is devoid of one or more of the ingredients detailed in any one of EMBODIMENTS 4B to 7B and EMBODIMENTS 14B to 17B or any combination thereof.

EMBODIMENT 19B The hydrophilic treatment formulation of any one of EMBODIMENTS 1B to 18B, wherein the total percent solids by weight of the hydrophilic treatment formulation is at least about 5%, or between about 5% to about 95% (inclusive), in particular between about 27% to about 95% (inclusive), even more particular between about 35% to about 95% (inclusive).

EMBODIMENT 20B The hydrophilic treatment formulation of any one of EMBODIMENTS 1B to 19B, wherein said hydrophilic treatment formulation having a 60° C. evaporation load of at least about 1.86:1 by weight.

EMBODIMENT 21B The hydrophilic treatment formulation of any one of EMBODIMENTS 1B to 20B, wherein said at least one first non-ionic surfactant has a solubility in water of at least about 7%, at 25° C.

EMBODIMENT 22B The hydrophilic treatment formulation of any one of EMBODIMENTS 1B to 21B, wherein said at least one first non-ionic surfactant makes up between about 2.5% to about 95%, by weight, of the hydrophilic treatment formulation.

EMBODIMENT 23B The hydrophilic treatment formulation of any one of EMBODIMENTS 1B to 21B, wherein said hydrophilic treatment formulation comprises at least two first non-ionic surfactants or at least three first non-ionic surfactants, and wherein a total content of the at least two or at least three first non-ionic surfactants make up between about 2.5% to about 95%, by weight, of the hydrophilic treatment formulation.

EMBODIMENT 24B The hydrophilic treatment formulation of any one of EMBODIMENTS 1B to 23B, wherein said first non-ionic surfactant is a silicon containing surfactant or a non-silicon containing surfactant (e.g., polysorbate 20 i.e., Tween 20).

EMBODIMENT 25B The hydrophilic treatment formulation of any one of EMBODIMENTS 1B to 23B, wherein said at least one first non-ionic surfactant is a non-silicon containing surfactant.

EMBODIMENT 26B The hydrophilic treatment formulation of any one of EMBODIMENTS 1B to 23B, wherein one or more of the first non-ionic surfactants is a non-silicon containing surfactant.

EMBODIMENT 27B The hydrophilic treatment formulation of any one of EMBODIMENTS 1B to 26B, wherein said at least one second non-ionic surfactant has a solubility in water of at least 1%, at 25° C.

EMBODIMENT 28B The hydrophilic treatment formulation of any one of EMBODIMENTS 1B to 27B, wherein said at least one second non-ionic surfactant is a silicon containing surfactant (e.g., BYK LPX 23289) or a non-silicon containing surfactant.

EMBODIMENT 29B The hydrophilic treatment formulation of any one of EMBODIMENTS 1B to 27B, wherein said at least one second non-ionic surfactant is a non-silicon containing surfactant.

EMBODIMENT 30B The hydrophilic treatment formulation of any one of EMBODIMENTS 1B to 29B, wherein said second non-ionic surfactant making up at most 10%, by weight, (inclusive) of said hydrophilic treatment formulation.

EMBODIMENT 31B The hydrophilic treatment formulation of any one of EMBODIMENTS 1B to 29B, wherein said hydrophilic treatment formulation comprises at least two second non-ionic surfactants or at least three second non-ionic surfactants, and wherein a total content of the at least two or at least three second non-ionic surfactants make up at most 10%, by weight, (inclusive) of said hydrophilic treatment formulation.

EMBODIMENT 32B The hydrophilic treatment formulation of any one of EMBODIMENTS 1B to 31B, wherein one or more of the second non-ionic surfactants is a non-silicon containing surfactant.

EMBODIMENT 33B The hydrophilic treatment formulation of any one of EMBODIMENTS 1B to 32B, wherein said hydrophilic treatment formulation further comprises at least one wetting agent (e.g., polyethyleneimine), said wetting agent (e.g., polyethyleneimine) making up at most about 1%, by weight, of said hydrophilic treatment formulation, in particular at most about 0.20%, more particular 0.20% of said hydrophilic treatment formulation.

EMBODIMENT 34B The hydrophilic treatment formulation of any one of EMBODIMENTS 1B to 33B, wherein said humectant making up at most about 30%, by weight, of said hydrophilic treatment formulation.

EMBODIMENT 35B The hydrophilic treatment formulation of any one of EMBODIMENTS 1B to 34B, wherein said at least one humectant is a non-polymeric humectant.

EMBODIMENT 36B The hydrophilic treatment formulation of any one of EMBODIMENTS 1B to 35B, wherein said antibacterial agent making up at most about 1%, by weight, of said hydrophilic treatment formulation.

EMBODIMENT 37B The hydrophilic treatment formulation of any one of EMBODIMENTS 1B to 36B, wherein:
said at least one first non-ionic surfactant making up between about 2.5% to about 95%, by weight, of the hydrophilic treatment formulation;
said at least one second non-ionic surfactant making up at most 10%, by weight, (inclusive) of said hydrophilic treatment formulation;
said at least one wetting agent (e.g., polyethyleneimine) making up at most about 1%, by weight, of said hydrophilic treatment formulation, in particular at most about 0.20%, more particular 0.20% of said hydrophilic treatment formulation;
said at least one humectant making up at most about 30%, by weight, of said hydrophilic treatment formulation; and
said at least one antibacterial agent making up at most about 1%, by weight, of said hydrophilic treatment formulation.

EMBODIMENT 38B The hydrophilic treatment formulation of any one of EMBODIMENTS 1B to 37B, wherein said hydrophilic treatment formulation is devoid of a silicon surfactant.

EMBODIMENT 39B The hydrophilic treatment formulation of any one of EMBODIMENTS 1B to 38B, wherein the ingredients of said hydrophilic treatment formulation are compatible with each other and with the liquid containing water.

EMBODIMENT 40B The hydrophilic treatment formulation of any one of EMBODIMENTS 1B to 39B, wherein said hydrophilic treatment formulation being a stable solution with no phase separation and with no sedimentation/precipitation at 25° C.

EMBODIMENT 41B The hydrophilic treatment formulation of any one of EMBODIMENTS 1B to 40B, wherein said hydrophilic treatment formulation being a clear colorless solution at 25° C.

EMBODIMENT 42B The hydrophilic treatment formulation of any one of EMBODIMENTS 1B to 41B, wherein the ingredients of said hydrophilic treatment formulation do not form aggregates with the colorant of an aqueous ink utilized in a printing system or method.

EMBODIMENT 43B A method of indirect printing comprising:
a. providing an intermediate transfer member (ITM) comprising a release layer surface;
b. providing the hydrophilic treatment formulation of any one of EMBODIMENTS 1B to 42B;
c. applying the hydrophilic treatment formulation onto the release layer surface of the ITM to form thereon a wet treatment layer optionally having a thickness of at most about 5.0 μm;
d. drying said wet treatment layer to thereby form a dried non-cohesive sweating treatment layer from the wet treatment layer on the ITM release layer surface, said dried non-cohesive sweating treatment layer optionally having a thickness of at least about 20 nm and at most about 500 nm;
e. depositing droplets of an aqueous ink, said aqueous ink comprising at least one binder and at least one colorant, onto at least a region of the dried non-cohesive sweating treatment layer, to form an ink image on the ITM release layer surface:
f. drying the ink image to leave an ink-image residue on the ITM release layer surface; and
g. transferring the ink-image residue onto a printing substrate by pressured contact between the ITM and the printing substrate.

EMBODIMENT 44B The method of EMBODIMENT 43B, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

EMBODIMENT 45B The method of EMBODIMENT 43B or 44B, wherein said hydrophilic treatment formulation is substantially devoid of a cohesive substance and/or a cohesion inducing substance thereby once said hydrophilic treatment formulation is dried on the release layer surface of the ITM it does not form a film layer thereon.

EMBODIMENT 46B The method of any one of EMBODIMENTS 43B to 45B, wherein said drying in step (d) is performed at a temperature of between about 90° C. to about 130° C., inclusive.

EMBODIMENT 47B The method of any one of EMBODIMENTS 43B to 46B, wherein said dried non-cohesive sweating treatment layer is comprised of a solid material or a semisolid material sweated with a non-volatile liquid oil.

EMBODIMENT 48B The method of any one of EMBODIMENTS 43B to 47B, wherein said dried non-cohesive sweating treatment layer is colorless.

EMBODIMENT 49B The method of any one of EMBODIMENTS 43B to 48B, wherein the ingredients of said hydrophilic treatment formulation do not form aggregates with the colorant of said aqueous ink.

EMBODIMENT 50B The method of any one of EMBODIMENTS 43B to 49B, wherein in step (g), to some extent, the dry non-cohesive sweating treatment layer, in both printed and non-printed regions on the ITM, is transferred to the printing substrate, together with the ink-image residue, leaving a residual dry non-cohesive sweating treatment layer on the ITM or a residual dry non-cohesive non-sweating treatment layer on the ITM.

EMBODIMENT 51B The method of EMBODIMENT 50B, wherein said method comprises several repeating cycles of steps (c) to (g) (e.g., 1000 cycles), and wherein between each cycle the newly applied hydrophilic treatment formulation in step (c) completely dissolves said residual dry non-cohesive sweating treatment layer or said residual dry non-cohesive non-sweating treatment layer of the previous cycle, thereby no accumulation of said residual layer/s between each of said cycles occurs.

EMBODIMENT 52B The method of any one of EMBODIMENTS 43B to 51B, wherein when said droplets of said aqueous ink are deposited onto the dry non-cohesive sweating treatment layer, a surface of said dry non-cohesive sweating treatment layer, which is in close contact with said aqueous ink, is capable of dissolving into said aqueous ink and/or mix and/or blend with said aqueous ink, optionally forming an intermediate phase comprising one or more ingredients of said hydrophilic treatment formulation and the ink ingredients.

EMBODIMENT 53B The method of any one of EMBODIMENTS 43B to 52B, wherein the ink-image residue further comprises one or more ingredients of said hydrophilic treatment formulation.

EMBODIMENT 54B The method of any one of EMBODIMENTS 43B to 53B, wherein the ink-image residue is free of aggregates.

EMBODIMENT 55B A system for indirect printing, the system comprising:
a. an intermediate transfer member (ITM) comprising a release layer surface;
b. a quantity of the hydrophilic treatment formulation of any one of EMBODIMENTS 1B to 42B;
c. a treatment station for applying the hydrophilic treatment formulation to the release layer surface of the ITM to form thereon a wet treatment layer optionally having a thickness of at most 5.0 μm:
d. means for subjecting the wet treatment layer to a drying process to form a dried non-cohesive sweating treatment layer from the wet treatment layer on the ITM release layer surface, said dried non-cohesive sweating treatment layer optionally having a thickness of at least about 20 nm and at most about 500 nm;
e. at least one ink jet nozzle positioned proximate the intermediate transfer member and configured for jetting aqueous ink droplets, comprising at least one binder and at least one colorant, onto at least a region of the dried non-cohesive sweating treatment layer formed on the intermediate transfer member;
f. a drying station for drying the ink on the dried non-cohesive sweating treatment layer formed on the intermediate transfer member to leave an ink-image residue on the ITM release layer surface; and
g. an impression station for transferring the ink-image residue onto a printing substrate by pressured contact between the ITM and the printing substrate.

EMBODIMENT 56B The system of EMBODIMENT 55B, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

EMBODIMENT 57B The system of EMBODIMENT 55B or 56B, for preforming the method of any one of EMBODIMENTS 43B to 54B.

EMBODIMENT 58B A printed article comprising:
(i) a substrate;
(ii) one or more dry ink dots fixedly adhered to at least a region of a surface of said substrate,
wherein said one or more dry ink dots comprise at least one binder, at least one colorant and one or more of non-volatile ingredients of the hydrophilic treatment formulations of any one of EMBODIMENTS 1B to 42B.

EMBODIMENT 59B The printed article of EMBODIMENTS 58B, wherein said dry one or more ink dots are further covered with a dry non-cohesive sweating layer comprising one or more of the non-volatile ingredients of said hydrophilic treatment formulation.

EMBODIMENT 60B The printed article of EMBODIMENT 58B or 59B, wherein non printed regions of said substrate are covered with a dry non-cohesive sweating layer comprising one or more of the non-volatile ingredients of the hydrophilic treatment formulation.

EMBODIMENT 61B The printed article of any one of EMBODIMENTS 58B to 60B, produced according to the method of any one of EMBODIMENTS 43B to 54B.

EMBODIMENT 62B An intermediate transfer member comprising a release layer surface, wherein said surface is substantially covered with a dry non-cohesive sweating layer comprising one or more of the non-volatile ingredients of the hydrophilic treatment formulation of any one of EMBODIMENTS 1B to 42B, and optionally wherein the thickness of said dry non-cohesive sweating layer being of at least about 20 nm and at most about 500 nm.

EMBODIMENT 63B The intermediate transfer member of EMBODIMENTS 62B, wherein the dry non-cohesive sweating layer covers at least 50% or at least 75% or at least 90% or at least 95% at least 95% or at least 99% or 100% of the intermediate transfer member release layer surface.

EMBODIMENT 64B An intermediate transfer member comprising a release layer surface, wherein said surface is substantially covered with the hydrophilic treatment formulation of any one of EMBODIMENTS 1B to 42B.

EMBODIMENT 65B An intermediate transfer member comprising a release layer surface, wherein said surface is substantially covered with the hydrophilic treatment formulation of any one of EMBODIMENTS 1B to 42B, and wherein when said intermediate transfer member is at a temperature being of between about 90° C. to about 130° C., a dried non-cohesive sweating treatment layer is form thereon, optionally wherein the thickness of said dry non-cohesive sweating layer being of at least about 20 nm and at most about 500 nm.

EMBODIMENT 66B The intermediate transfer member of any one of EMBODIMENTS 62B to 65B, comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

1. A hydrophilic treatment formulation for use with an intermediate transfer member (ITM) of a printing system, the hydrophilic treatment formulation comprising:
i. a liquid containing water, said liquid containing water making up between about 5% to about 97.5%, by weight, of the hydrophilic treatment formulation;
ii. at least one first non-ionic surfactant;
wherein said hydrophilic treatment formulation optionally further comprises one or more of:
iii. at least one second non-ionic surfactant;
iv. at least one humectant;
V. at least one wetting agent optionally being a first water-soluble polymeric wetting agent; and
vi. at least one antibacterial agent;
wherein a dry form of said hydrophilic treatment formulation is a non-cohesive form of a solid or semisolid material sweated with a non-volatile liquid oil.

2. The hydrophilic treatment formulation of claim 1, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

3. The hydrophilic treatment formulation of claim 1 or 2, wherein said hydrophilic treatment formulation having the following properties:
i. a static surface tension within a range of 20 and 40 mN/m at 25° C.;
ii. a 25° C. dynamic viscosity that is at least 10 cP; and
iii. a 60° C. evaporation load of at least about 0.05:1 and at most about 19:1, by weight.

4. The hydrophilic treatment formulation of any one of claims 1 to 3, wherein said hydrophilic treatment formulation is devoid of a second water-soluble polymer, said second water-soluble polymer being different from the first water-soluble polymeric wetting agent and wherein said second water-soluble polymer is a cohesive substance and/or a cohesion inducing substance.

5. The hydrophilic treatment formulation of claim 4, wherein said second water-soluble polymer is a water absorbing polymeric agent.

6. The hydrophilic treatment formulation of claim 4, wherein said hydrophilic treatment formulation is substantially devoid of a further cohesive substance and/or a cohesion inducing substance.

7. The hydrophilic treatment formulation of any one of claims 1 to 6, wherein said hydrophilic treatment formulation is substantially devoid of a film forming agent.

8. The hydrophilic treatment formulation of any one of claims 1 to 7, wherein said liquid containing water is water only or a mixture of water and at least one water soluble organic solvent.

9. The hydrophilic treatment formulation of any one of claims 1 to 8, wherein said hydrophilic treatment formulation further comprises at least one first water-soluble polymeric wetting agent.

10. The hydrophilic treatment formulation of any one of claims 1 to 9, wherein said first water-soluble polymeric wetting agent is a multiple charged polymer e.g., a polycation or a polyanion.

11. The hydrophilic treatment formulation of claim 10, wherein said polycation is selected from the group consisting of polyethyleneimine (PEI), poly (amidoamine) (PAMAM), poly-l-lysine (PLL) and poly (diallyl dimethyl ammonium) (PDDA).

12. The hydrophilic treatment formulation of claim 10, wherein said polyanion is selected from the group consisting of acrylic polymers, polyacryl amides and poly-DADMAc.

13. The hydrophilic treatment formulation of claim 10, wherein said first water-soluble polymeric wetting agent is PEI.

14. The hydrophilic treatment formulation of any one of claims 1 to 13, wherein apart from said first water-soluble polymeric wetting agent and/or said at least one first non-ionic surfactant, said hydrophilic treatment formulation is devoid of a substance with a molecular weight being of about 1300 gr/mol and above.

15. The hydrophilic treatment formulation of any one of claims 1 to 14, wherein said hydrophilic treatment formulation is further devoid of one or more of an inorganic salt, an inorganic metallic compound, a polyvalent metal ion and a metal ion.

16. The hydrophilic treatment formulation of any one of claims 1 to 15, wherein said hydrophilic treatment formulation is further devoid of an acid.

17. The hydrophilic treatment formulation of any one of claims 1 to 16, wherein said hydrophilic treatment formulation is further devoid of a resolubilizing agent.

18. The hydrophilic treatment formulation of any one of claims 1 to 17, wherein said hydrophilic treatment formulation is devoid of one or more of the ingredients detailed in any one of claims 4-7 and claims 14-17 or any combination thereof.

19. The hydrophilic treatment formulation of any one of claims 1 to 18, wherein the total percent solids by weight of the hydrophilic treatment formulation is at least about 5%, or between about 5% to about 95%, in particular between about 27% to about 95%, even more particular between about 35% to about 95%.

20. The hydrophilic treatment formulation of any one of claims 1 to 19, wherein said hydrophilic treatment formulation having a 60° C. evaporation load of at least about 1.86:1 by weight.

21. The hydrophilic treatment formulation of any one of claims 1 to 20, wherein said at least one first non-ionic surfactant has a solubility in water of at least about 7%, at 25° C.

22. The hydrophilic treatment formulation of any one of claims 1 to 21, wherein said at least one first non-ionic surfactant makes up between about 2.5% to about 95%, by weight, of the hydrophilic treatment formulation.

23. The hydrophilic treatment formulation of any one of claims 1 to 21, wherein said hydrophilic treatment formulation comprises at least two first non-ionic surfactants or at least three first non-ionic surfactants, and wherein a total content of the at least two or at least three first non-ionic surfactants make up between about 2.5% to about 95%, by weight, of the hydrophilic treatment formulation.

24. The hydrophilic treatment formulation of any one of claims 1 to 23, wherein said at least one first non-ionic surfactant is a silicon containing surfactant or a non-silicon containing surfactant.

25. The hydrophilic treatment formulation of any one of claims 1 to 23, wherein said at least one first non-ionic surfactant is a non-silicon containing surfactant.

26. The hydrophilic treatment formulation of any one of claims 1 to 23, wherein one or more of the first non-ionic surfactants is a non-silicon containing surfactant.

27. The hydrophilic treatment formulation of any one of claims 1 to 26, wherein said at least one second non-ionic surfactant has a solubility in water of at least 1%, at 25° C.

28. The hydrophilic treatment formulation of any one of claims 1 to 27, wherein said at least one second non-ionic surfactant is a silicon containing surfactant or a non-silicon containing surfactant.

29. The hydrophilic treatment formulation of any one of claims 1 to 27, wherein said at least one second non-ionic surfactant is a non-silicon containing surfactant.

30. The hydrophilic treatment formulation of any one of claims 1 to 29, wherein said second non-ionic surfactant making up at most 10%, by weight of said hydrophilic treatment formulation.

31. The hydrophilic treatment formulation of any one of claims 1 to 29, wherein said hydrophilic treatment formulation comprises at least two second non-ionic surfactants or at least three second non-ionic surfactants, and wherein a total content of the at least two or at least three second non-ionic surfactants make up at most 10%, by weight of said hydrophilic treatment formulation.

32. The hydrophilic treatment formulation of any one of claims 1 to 31, wherein one or more of the second non-ionic surfactants is a non-silicon containing surfactant.

33. The hydrophilic treatment formulation of any one of claims 1 to 32, wherein said hydrophilic treatment formulation further comprises at least one wetting agent, said wetting agent making up at most about 1%, by weight, of said hydrophilic treatment formulation, in particular at most about 0.20%, more particular 0.20% of said hydrophilic treatment formulation.

34. The hydrophilic treatment formulation of any one of claims 1 to 33, wherein said humectant making up at most about 30%, by weight, of said hydrophilic treatment formulation.

35. The hydrophilic treatment formulation of any one of claims 1 to 34, wherein said at least one humectant is a non-polymeric humectant.

36. The hydrophilic treatment formulation of any one of claims 1 to 35, wherein said antibacterial agent making up at most about 1%, by weight, of said hydrophilic treatment formulation.

37. The hydrophilic treatment formulation of any one of claims 1 to 36, wherein:
said at least one first non-ionic surfactant making up between about 2.5% to about 95%, by weight, of the hydrophilic treatment formulation;
said at least one second non-ionic surfactant making up at most 10%, by weight of said hydrophilic treatment formulation;
said at least one wetting agent making up at most about 1%, by weight, of said hydrophilic treatment formulation, in particular at most about 0.20%, more particular 0.20% of said hydrophilic treatment formulation;
said at least one humectant making up at most about 30%, by weight, of said hydrophilic treatment formulation; and
said at least one antibacterial agent making up at most about 1%, by weight, of said hydrophilic treatment formulation.

38. The hydrophilic treatment formulation of any one of claims 1 to 37, wherein said hydrophilic treatment formulation is devoid of a silicon surfactant.

39. The hydrophilic treatment formulation of any one of claims 1 to 38, wherein the ingredients of said hydrophilic treatment formulation are compatible with each other and with the liquid containing water.

40. The hydrophilic treatment formulation of any one of claims 1 to 39, wherein said hydrophilic treatment formulation being a stable solution with no phase separation and with no sedimentation/precipitation at 25° C.

41. The hydrophilic treatment formulation of any one of claims 1 to 40 wherein said hydrophilic treatment formulation being a clear colorless solution at 25° C.

42. The hydrophilic treatment formulation of any one of claims 1 to 41, wherein the ingredients of said hydrophilic treatment formulation do not form aggregates with the colorant of an aqueous ink utilized in a printing system or method.

43. A method of indirect printing comprising:
a. providing an intermediate transfer member (ITM) comprising a release layer surface;
b. providing the hydrophilic treatment formulation of any one of claims 1 to 42;
c. applying the hydrophilic treatment formulation onto the release layer surface of the ITM to form thereon a wet treatment layer optionally having a thickness of at most about 5.0 μm;
d. drying said wet treatment layer to thereby form a dried non-cohesive sweating treatment layer from the wet treatment layer on the ITM release layer surface, said dried non-cohesive sweating treatment layer optionally having a thickness of at least about 20 nm and at most about 500 nm;
e. depositing droplets of an aqueous ink, said aqueous ink comprising at least one binder and at least one colorant, onto at least a region of the dried non-cohesive sweating treatment layer, to form an ink image on the ITM release layer surface:
f. drying the ink image to leave an ink-image residue on the ITM release layer surface; and
g. transferring the ink-image residue onto a printing substrate by pressured contact between the ITM and the printing substrate.

44. The method of claim 43, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

45. The method of claim 43 or 44, wherein said hydrophilic treatment formulation is substantially devoid of a cohesive substance and/or a cohesion inducing substance thereby once said hydrophilic treatment formulation is dried on the release layer surface of the ITM it does not form a film layer thereon.

46. The method of any one of claims 43 to 45, wherein said drying in step (d) is performed at a temperature of between about 90° C. to about 130° C., inclusive.

47. The method of any one of claims 43 to 46, wherein said dried non-cohesive sweating treatment layer is comprised of a solid material or a semisolid material sweated with a non-volatile liquid oil.

48. The method of any one of claims 43 to 47, wherein said dried non-cohesive sweating treatment layer is colorless.

49. The method of any one of claims 43 to 48, wherein the ingredients of said hydrophilic treatment formulation do not form aggregates with the colorant of said aqueous ink.

50. The method of any one of claims 43 to 49, wherein in step (g), to some extent, the dry non-cohesive sweating treatment layer, in both printed and non-printed regions on the ITM, is transferred to the printing substrate, together with the ink-image residue, leaving a residual dry non-cohesive sweating treatment layer on the ITM or a residual dry non-cohesive non-sweating treatment layer on the ITM.

51. The method of claim 50, wherein said method comprises several repeating cycles of steps (c) to (g) (e.g., 1000 cycles), and wherein between each cycle the newly applied hydrophilic treatment formulation in step (c) completely dissolves said residual dry non-cohesive sweating treatment layer or said residual dry non-cohesive non-sweating treatment layer of the previous cycle, thereby no accumulation of said residual layer/s between each of said cycles occurs.

52. The method of any one of claims 43 to 51, wherein when said droplets of said aqueous ink are deposited onto the dry non-cohesive sweating treatment layer, a surface of said dry non-cohesive sweating treatment layer, which is in close contact with said aqueous ink, is capable of dissolving into said aqueous ink and/or mix and/or blend with said aqueous ink, optionally forming an intermediate phase comprising one or more ingredients of said hydrophilic treatment formulation and the ink ingredients.

53. The method of any one of claims 43 to 52, wherein the ink-image residue further comprises one or more ingredients of said hydrophilic treatment formulation.

54. The method of any one of claims 43 to 53, wherein the ink-image residue is free of aggregates.

55. A system for indirect printing, the system comprising:
a. an intermediate transfer member (ITM) comprising a release layer surface;
b. a quantity of the hydrophilic treatment formulation of any one of claims 1 to 42;
c. a treatment station for applying the hydrophilic treatment formulation to the release layer surface of the ITM to form thereon a wet treatment layer optionally having a thickness of at most 5.0 μm:
d. means for subjecting the wet treatment layer to a drying process to form a dried non-cohesive sweating treatment layer from the wet treatment layer on the ITM release layer surface, said dried non-cohesive sweating treatment layer optionally having a thickness of at least about 20 nm and at most about 500 nm;
e. at least one ink jet nozzle positioned proximate the intermediate transfer member and configured for jetting aqueous ink droplets, comprising at least one binder and at least one colorant, onto at least a region of the dried non-cohesive sweating treatment layer formed on the intermediate transfer member;
f. a drying station for drying the ink on the dried non-cohesive sweating treatment layer formed on the intermediate transfer member to leave an ink-image residue on the ITM release layer surface; and
g. an impression station for transferring the ink-image residue onto a printing substrate by pressured contact between the ITM and the printing substrate.

56. The system of claim 55, wherein said ITM comprises a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.

57. The system of claim 55 or 56, for preforming the method of any one of claims 43 to 54.

58. A printed article comprising:
(i) a substrate;
(ii) one or more dry ink dots fixedly adhered to at least a region of a surface of said substrate,
wherein said one or more dry ink dots comprise at least one binder, at least one colorant and one or more of non-volatile ingredients of the hydrophilic treatment formulations of any one of claims 1 to 42.

59. The printed article of claim 58, wherein said dry one or more ink dots are further covered with a dry non-cohesive sweating layer comprising one or more of the non-volatile ingredients of said hydrophilic treatment formulation.

60. The printed article of claim 58 or 59, wherein non printed regions of said substrate are covered with a dry non-cohesive sweating layer comprising one or more of the non-volatile ingredients of the hydrophilic treatment formulation.

61. The printed article of any one of claims 58 to 60, produced according to the method of any one of claims 43 to 54.

62. An intermediate transfer member comprising a release layer surface, wherein said surface is substantially covered with a dry non-cohesive sweating layer comprising one or more of the non-volatile ingredients of the hydrophilic treatment formulation of any one of claims 1 to 42, and optionally wherein the thickness of said dry non-cohesive sweating layer being of at least about 20 nm and at most about 500 nm.

63. The intermediate transfer member of claim 62, wherein the dry non-cohesive sweating layer covers at least 50% or at least 75% or at least 90% or at least 95% at least 95% or at least 99% or 100% of the intermediate transfer member release layer surface.

64. An intermediate transfer member comprising a release layer surface, wherein said surface is substantially covered with the hydrophilic treatment formulation of any one of claims 1 to 42.

65. An intermediate transfer member comprising a release layer surface, wherein said surface is substantially covered with the hydrophilic treatment formulation of any one of claims 1 to 42, and wherein when said intermediate transfer member is at a temperature being of between about 90° C. to about 130° C., a dried non-cohesive sweating treatment layer is form thereon, optionally wherein the thickness of said dry non-cohesive sweating layer being of at least about 20 nm and at most about 500 nm.

66. The intermediate transfer member of any one of claims 62 to 65, comprising a silicone-based release layer surface that is sufficiently hydrophilic to satisfy at least one of the following properties:
(i) a receding contact angle of a drop of distilled water deposited on the silicone-based release layer surface is at most 60°; and
(ii) a 10-second dynamic contact angle (DCA) of a drop of distilled water deposited on the silicone-based release layer surface is at most 108°.
